(19) United States
(12) Patent Application Publication
(10) Pub. No.: US 2006/0247973 A1
(43) Pub. Date: Nov. 2, 2006

(54) METHOD AND APPARATUS FOR DYNAMIC RULE AND/OR OFFER GENERATION

(76) Inventors: Raymond J. Mueller, Weston, CT (US); Andrew S. Van Luchene, New York, NY (US); Jeffrey E. Heier, Somers, NY (US); Christine Amorossi, Brookfield, CT (US); Srikant Krishna, Holmdel, NJ (US); Ted Markowitz, Darien, CT (US)

Correspondence Address: WALKER DIGITAL, 2 HIGH RIDGE PARK, STAMFORD, CT, 06905, US

(21) Appl. No.: 11/456,289

(22) Filed: Jul. 10, 2006

Related U.S. Application Data
(63) Continuation of application No. 09/993,228, filed on Nov. 14, 2001.
(60) Provisional application No. 60/248,234, filed on Nov. 14, 2000.

(51) Int. Cl. G06Q 30/00

(52) U.S. Cl. 705/14; 705/26

(57) ABSTRACT

Systems and methods are provided for receiving order information based on an order of a customer; and determining an offer for the customer based on the order information and at least one of a genetic program and a genetic algorithm.

This application claims the benefit of U.S. Patent Application Ser. No. 60/248,234, entitled DYNAMIC RULE AND/OR OFFER GENERATION IN A NETWORK OF POINT-OF-SALE TERMINALS, the entire contents of which are incorporated herein by reference as part of the present disclosure.

### CROSS-REFERENCE TO RELATED APPLICATIONS

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000. The entire contents of these applications and/or patents are incorporated herein by reference as part of the present disclosure.

### REFERENCE TO COMPUTER PROGRAM LISTING APPENDIX

A computer program listing appendix has been submitted on two compact discs. All material on the compact discs is incorporated herein by reference as part of the present disclosure. There are two (2) compact discs, one (1) original and one (1) duplicate, and each compact disc includes the following ninety files:

| | SIZE | DATE |
|---|---|---|
| FILE NAME | IN BYTES | CREATED |
| ActionSet.java | 26,409 | Oct. 31, 2001 |
| ArmTimerOrderProcessor.java | 7,095 | Oct. 26, 2001 |
| BayesRule.java | 6,274 | Oct. 26, 2001 |
| BioNET.java | 22,152 | Oct. 24, 2001 |
| BioNetDatabase.java | 40,708 | Nov. 1, 2001 |
| BioNetNonTerminalException.java | 5,108 | Oct. 30, 2001 |
| BioNetTerminalException.java | 3,140 | Aug. 27, 2001 |
| BioNetUtilities.java | 11,850 | Oct. 18, 2001 |
| Classifier.java | 47,169 | Oct. 29, 2001 |
| ClassifierFieldManager.java | 8,385 | Oct. 30, 2001 |
| ClassifierPopulation.java | 25,894 | Oct. 30, 2001 |
| ClassifierSet.java | 12,784 | Oct. 30, 2001 |
| ClassifierStatistics.java | 13,778 | Oct. 29, 2001 |
| ClassifierSystem.java | 4,248 | Nov. 7, 2001 |
| ConditionalProbability.java | 3,433 | Oct. 26, 2001 |
| ConditionalProbabilityMap.java | 5,566 | Oct. 17, 2001 |
| ConditionalProbabilityMap_Double.java | 2,090 | Oct. 17, 2001 |
| ConditionalProbabilityMap_Integer.java | 1,760 | Oct. 17, 2001 |
| ConditionalProbability_Integer.java | 4,059 | Oct. 26, 2001 |
| ConfigurationEvent.java | 3,373 | Oct. 29, 2001 |
| ConfigurationEventListener.java | 899 | Sep. 4, 2001 |
| DatabaseField.java | 1,773 | Aug. 27, 2001 |
| DBbioNETConfig.java | 15,479 | Oct. 30, 2001 |
| DBcashiers.java | 3,909 | Oct. 31, 2001 |
| DBconfig.java | 4,747 | Oct. 31, 2001 |
| DBdataSubsystem.java | 1,548 | Nov. 2, 2001 |
| DBdataSubsystemFactory.java | 9,749 | Oct. 28, 2001 |
| DBdataSubsystemFactoryPhase1.java | 3,914 | Oct. 28, 2001 |
| DBdataSubsystemFactoryPhase2.java | 3,909 | Oct. 28, 2001 |
| DBdestinations.java | 4,264 | Oct. 31, 2001 |
| DBintDescription.java | 7,553 | Oct. 31, 2001 |
| DBmappedNodes.java | 13,742 | Oct. 31, 2001 |
| DBmenuItem.java | 41,161 | Nov. 6, 2001 |
| DBmenuItemPeriod.java | 19,505 | Nov. 6, 2001 |
| DBmenuItemPhase1.java | 7,273 | Nov. 1, 2001 |
| DBmenuItemProbability.java | 7,266 | Nov. 1, 2001 |
| DBmenuItems.java | 51,588 | Nov. 6, 2001 |
| DBmenuItemsPhase1.java | 4,819 | Nov. 1, 2001 |
| DBperiod.java | 14,043 | Nov. 4, 2001 |
| DBperiodCounts.java | 5,320 | Nov. 4, 2001 |
| DBperiods.java | 27,560 | Nov. 6, 2001 |
| DBregisters.java | 4,228 | Oct. 31, 2001 |
| DebugPrintNothing.java | 1,861 | Nov. 2, 2001 |
| DebugPrintOut.java | 8,181 | Nov. 2, 2001 |
| DigitalDealDatabase.java | 4,175 | Oct. 31, 2001 |
| Evolvable.java | 1,301 | Nov. 2, 2001 |
| EvolverAgent.java | 3,676 | Nov. 2, 2001 |
| GeneratesOffers.java | 1,575 | Nov. 2, 2001 |
| HasNamedFields.java | 1,319 | Nov. 2, 2001 |
| IdenticalOfferAgent.java | 3,467 | Nov. 2, 2001 |
| IdenticalOfferInterface.java | 1,376 | Nov. 2, 2001 |
| InitializeFromResultSet.java | 1,336 | Aug. 27, 2001 |
| Lcs.java | 17,294 | Oct. 30, 2001 |
| LcsItem.java | 2,038 | Nov. 2, 2001 |
| LearnerAgent.java | 6,017 | Nov. 6, 2001 |
| Learns.java | 1,637 | Nov. 2, 2001 |
| MappedNodeInterface.java | 1,254 | Oct. 18, 2001 |
| MappedNodeManager.java | 1,883 | Oct. 18, 2001 |
| MapsPeriodIds.java | 1,202 | Oct. 9, 2001 |
| MenuItemEvent.java | 6,027 | Nov. 1, 2001 |
| MenuItemListener.java | 1,238 | Nov. 1, 2001 |
| ObservedOutcomes.java | 1,812 | Oct. 17, 2001 |
| Offerable.java | 2,042 | Nov. 5, 2001 |
| Offerables.java | 3,005 | Oct. 25, 2001 |
| OfferGeneratingInstance.java | 4,952 | Nov. 6, 2001 |
| OfferGenerator.java | 5,139 | Oct. 19, 2001 |
| OfferItem.java | 20,105 | Nov. 6, 2001 |
| OfferPoolCreator.java | 8,324 | Oct. 26, 2001 |
| Order.java | 15,403 | Oct. 29, 2001 |
| Orderable.java | 1,346 | Nov. 5, 2001 |
| Orderables.java | 1,998 | Oct. 16, 2001 |
| OrderItem.java | 8,136 | Nov. 5, 2001 |
| OrderProcessor.java | 8,737 | Sep. 27, 2001 |
| OverDollarOfferPoolCreator.java | 2,173 | Oct. 26, 2001 |
| PeriodCounts.java | 789 | Nov. 4, 2001 |
| PeriodIdMapper.java | 2,162 | Oct. 26, 2001 |
| PredictionArray.java | 13,648 | Oct. 29, 2001 |
| RefreshAgent.java | 1,769 | Oct. 24, 2001 |
| RefreshListener.java | 1,384 | Nov. 2, 2001 |
| SqlStatement.java | 16,751 | Oct. 24, 2001 |
| StateEvent.java | 2,986 | Oct. 2, 2001 |
| StateEventListener.java | 875 | Sep. 20, 2001 |
| SystemParameters.java | 18,660 | Oct. 29, 2001 |
| TimerArmedOrderProcessor.java | 4,747 | Sep. 26, 2001 |
| TimerThread.java | 1,304 | Oct. 24, 2001 |
| Updatable.java | 1,398 | Oct. 29, 2001 |
| UpgradeAgent.java | 2,644 | Oct. 25, 2001 |
| WakeUpAction.java | 880 | Aug. 28, 2001 |
| XcsInstance.java | 25,626 | Nov. 6, 2001 |
| XcsOfferItem.java | 7,860 | Oct. 29, 2001 |

### BACKGROUND OF THE INVENTION

Everyday, several companies spend significant sums of time and money in an effort to improve their operations. These efforts are manifested in various programs including training, communications, computer systems, product development and more. Historically, computerized systems have been instrumental in controlling costs and tracking performance within all of these disciplines. These systems have grown in flexibility and capability and, in general, have been perfected. Newer systems, like RetailDNA's Digital Deal™ system, are emerging and are now focused on driving increases in revenues and profits. Some of these systems, like the Digital Deal, are rules based and often permit user modifications that can drive incremental performance improvements.

Unfortunately, these systems have not had a mechanism to help change behavior or improve themselves over time. Therefore, the results these systems are able to produce are dependent upon the discipline and performance of store and senior management or systems support personnel. For example, if the database within a labor scheduling package is not kept up to date or routinely “fine tuned” it may become ineffective.

It would be advantageous to provide a method and apparatus that overcame the drawbacks of the prior art.

### DETAILED DESCRIPTION OF THE INVENTION

The present invention can change the way business practices and processes are improved over time. The invention may be used to improve system parameters of systems such as the Digital Deal™. For example, a system that provides customers with dynamically-priced upsell offers (defined below) may be improved to make offers that are more likely to be accepted. A description of systems that can provide dynamically priced upsell offers may be found in the following U.S. Patent Applications:

U.S. patent application Ser. No. 09/083,483 entitled “Method and Apparatus for Selling an Aging Food Product” and filed May 22, 1998; U.S. patent application Ser. No. 08/920,116 entitled “Method and System for Processing Supplementary Product Sales at a Point-Of-Sale Terminal” and filed Aug. 26, 1997; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997.

Further, the present invention can permit and enable other rules-based applications to become “self improving.”

Various embodiments of the present invention can take advantage of a multitude of data sources and transform these data into genetic codes or ‘synthetic’ DNA. The DNA is then used within an artificial biological environment, which the embodiments of the present invention can replicate. For example, each transaction may be analogized to an individual (species) in a population. When transactions are proven successful under certain environmental conditions (e.g., particular cashier or customer, time of day, day of week, certain store configuration, whether the destination is drive through or dine in, customer demographics), embodiments of the present invention can “propagate” that success. By culling unsuccessful transactions from the synthetic ecosystem, embodiments of the present invention can help eliminate undesirable transactions. Conversely, embodiments of the present invention can encourage the propagation of successful transactions, which drives incremental performance improvements.

The following is an example of one embodiment of the present invention, offered for illustration only.

RetailDNA offers a product referred to as the Digital Deal™, which dynamically generates suggestive sell offers that usually include some form of value proposition (or discount). Customers either accept the offer or they don't. By providing results data from the Digital Deal to the system described herein, overall customer accept rates and customer satisfaction may be improved. Each customer transaction (successful or not) can be translated into genetic strings or DNA. The transactions are measured as to their overall success ratings (success may be defined by subjectively according to any criteria) and includes (in this case), the percentage of customers accepting the deal and the value of the deal to the restaurant operator, and are propagated based upon these ratings. In this way, the system can exploit practices that are known to yield positive results according to various priorities.

In an effort to explore new possibilities, in various embodiments the system may periodically create new combinations of the DNA. In the preceding example, these new DNA combinations are new offers that have not yet been tried or written into rules. Embodiments of the present invention leverage success by distributing these new ideas. The more information that is made available to the system, the faster the system can improve results. Embodiments of the present invention can spread out new ideas over many sites. In such embodiments, the risk and costs associated with introducing a new strand are thereby reduced while simultaneously gathering significant results in a short period.

Embodiments of the present invention may also measure the actual results of both existing and new DNA and may continuously evolve to improve the overall effectiveness of the improved system. Since the whole process is automated, no human intervention is required to continuously improve. Thus, embodiments of the present invention can automatically adjust software settings to continuously generate incremental improvements in operational and financial performance., dramatically changing the way information systems affect the day-to-day operations of businesses. This may be accomplished by, e.g., creating a new model and method for involving and leveraging customers, systems and/or employees within an organization.

The computer program listing appendix included herein describes a program which may be used to practice an embodiment of the present invention.

### Definitions

The terms listed below shall be interpreted according to the following definitions in connection with this specification and the appended claims.

POS terminal—a device that is used in association with a purchase transaction and having some computing capabilities and/or being in communication with a device having computing capabilities. Examples of POS terminals include but are not limited to a cash register, a personal computer, a portable computer, a portable computing device such as a Personal Digital Assistant (PDA), a wired or wireless telephone, vending machines, automatic teller machine, a communication device, card authorization terminals, and/or credit card validation terminals.

Offer—an offer, promotion, proposal or advertising message communicated to a customer at a POS terminal, including upsell offers (such as dynamically-priced upsell offers), suggestive sell offers, switch-and-save offers, conditional subsidy offers, coupon offers, rebates, and discounts.

Upsell Offer—a proposal to a customer that he or she may purchase an additional product or service. For example, the customer may have an additional product or service added to a transaction.

Dynamically-priced upsell offer—an upsell offer in which the price to be charged for the additional product depends on a round-up amount associated with the transaction. For example, the round-up amount may be the difference between the transaction total (the amount the customer is required to pay without an upsell) and the next highest dollar amount greater than the transaction total. According to this specific example, if the transaction total without the upsell is $4.25, then the round-up amount is $0.75 ($5.00−$4.25=$0.75). In general, the round-up amount may also be based on the difference between any of a number of values associated with the transaction total and any other transaction total. For example, if the transaction total without the upsell is $87.50, the round-up amount may be $11.50, resulting in a new transaction total of $99.00. Other information, such as an amount of sales tax associated with the transaction, may also be used to determine the round-up amount.

Suggestive sell offer—an upsell offer in which the price to be paid for the additional item is a list, retail or standard price.

Switch-and-save offer—a proposal to a customer that another product be substituted for (or sold in lieu of) a product already included in a transaction. In various embodiments, the substitute product is offered and/or sold for less than its standard price.

Cross-subsidy offer (also referred to as a “conditional subsidy offer”)—an offer to provide a benefit (e.g., to subsidize a purchase price, to purchase a product for a lower price) from a third-party merchant in exchange for the customer performing and/or agreeing to perform one or more tasks. For example, a customer may be offered a benefit in exchange for the customer (i) applying for a service offered by a third-party, (ii) subscribing to a service offered by a third-party, (iii) receiving information such as an advertisement, and/or (iv) providing information such as answers to survey questions.

Several embodiments of the invention will now be described with reference to the drawings.

### System Overview

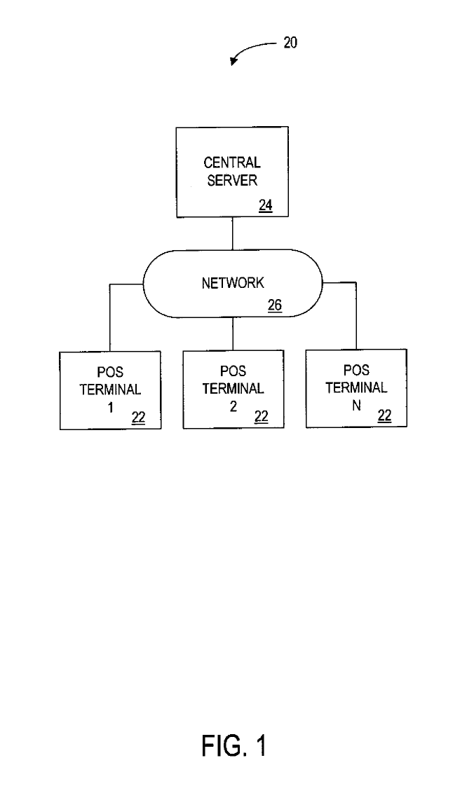

FIG. 1 illustrates, in the form of a block diagram, a simplified view of a POS network in which the present invention may be applied.

In FIG. 1, reference numeral 20 generally refers to the POS network. The network 20 is seen to include a plurality of POS terminals 22, of which only three are explicitly shown in FIG. 1. It should be understood that in various embodiments of the invention the number of POS terminals in the network may, for example, be as few as one, or, may number in the hundreds, thousands or millions. In certain embodiments, the POS terminals 22 in the POS network 20 may, but need not, all be constituted by identical hardware devices. In other embodiments dramatically different hardware devices may be employed as the POS terminals 22. Any standard type of POS terminal hardware may be employed, provided that it is suitable for programming or operation in accordance with the teachings of this invention. The POS terminals 22 may, for example, be “intelligent” devices of the types which incorporate a general purpose microprocessor or microcontroller. Alternatively, some or all of the POS terminals 22 may be “dumb” terminals, which are controlled, partially or substantially, by a separate device (e.g., a computing device) which is either in the same location with the terminal or located remotely therefrom.

Although not indicated in FIG. 1, the POS terminals 22 may be co-located (e.g., located within the same store, restaurant or other business location), or one or more of the POS terminals 22 may be located in a different location (e.g., located within different stores, restaurants or other business locations, in homes, in malls, changing mobile locations). Indeed, the invention may be applied in numerous store locations, each of which may have any number of POS terminals 22 installed therein. In one embodiment of the invention, the POS terminals 22 may be of the type utilized at restaurants, such as quick-service restaurants. According to one embodiment of the invention, POS terminals 22 in one location may communicate with a controller device (not shown in FIG. 1), which may in turn communicate with the server 24. Note that in certain embodiments of the present invention, all the elements shown in FIG. 1 may also be located in a single location.

Server 24 is connected for data communication with the POS terminals 22 via a communication network 26. The server 24 may comprise conventional computer hardware that is programmed in accordance with the invention. In various embodiments, the server 24 may comprise an application server and/or a database server.

The data communication network 26 may also interconnect the POS terminals 22 for communication with each other. The network 26 may be constituted by any appropriate combination of conventional data communication media, including terrestrial lines, radio waves, infrared, satellite data links, microwave links and the Internet. The network 26 may allow access to other sources of information, e.g., such as may be found on the Internet. In various embodiments the server 24 may be directly connected (e.g., connected without employing the network 26) with one or more of the POS terminals 22. Similarly, two or more of the POS terminals 22 may be directly connected (e.g., connected without employing the network 26).

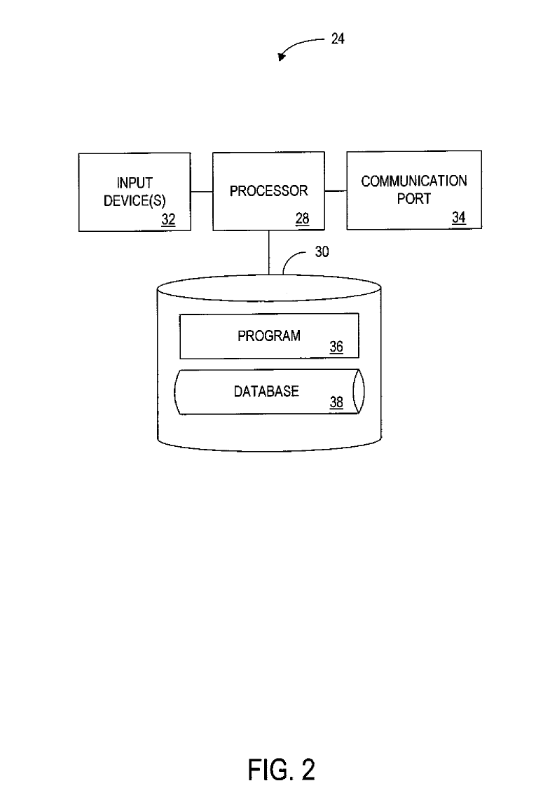

FIG. 2 is a simplified block diagram showing an exemplary embodiment for the server 24. The server 24 may be embodied, for example, as an RS 6000 server, manufactured by IBM Corporation, and programmed to execute functions and operations of the present invention. Any other known server may be similarly employed, as may any known device that can be programmed to operate appropriately in accordance with the description herein. The server 24 may includes known hardware components such as a processor 28 which is connected for data communication with each of one or more data storage devices 30, one or more input devices 32 and one or more communication ports 34. The communication port 34 may connect the server 24 to each of the POS terminals 22, thereby permitting the server 24 to communicate with the POS terminals. The communications port 34 may include multiple communication channels for simultaneous connections.

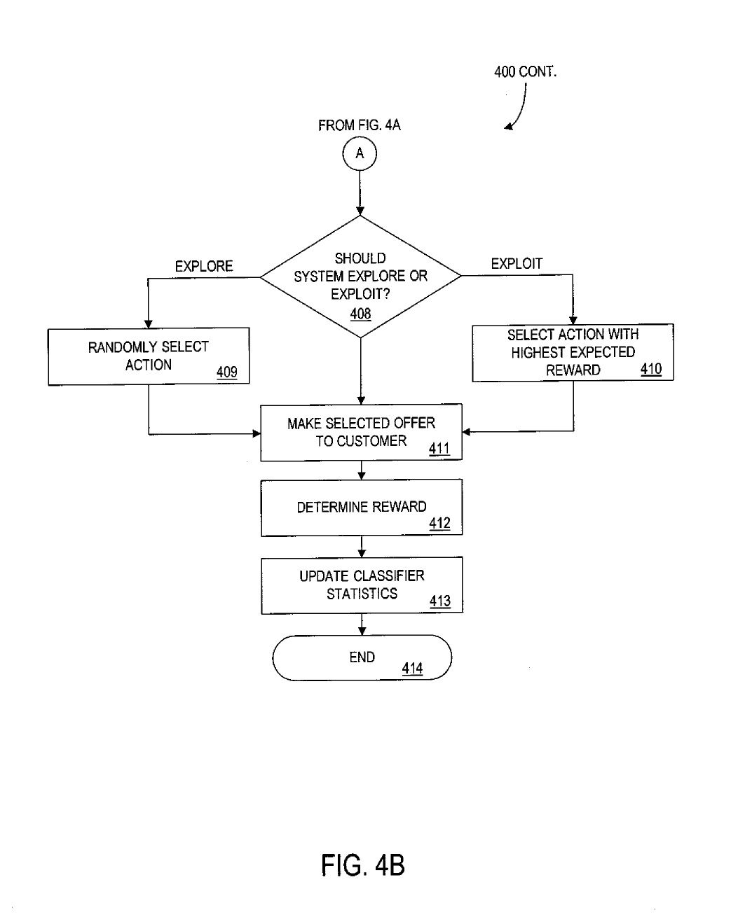

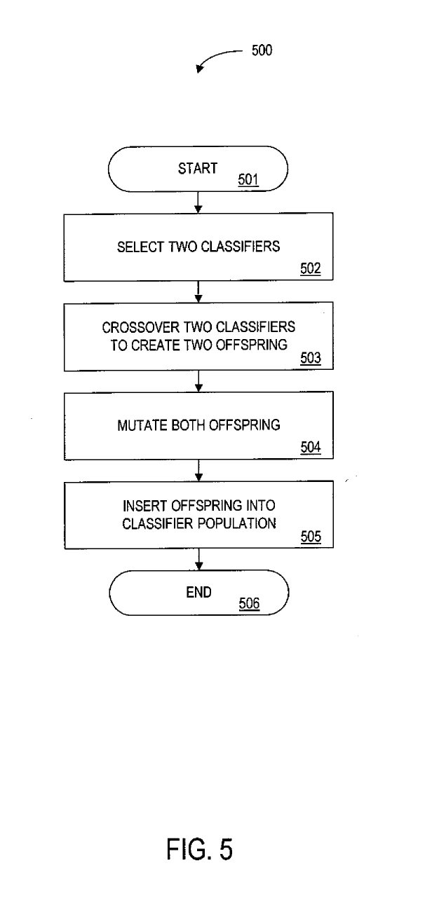

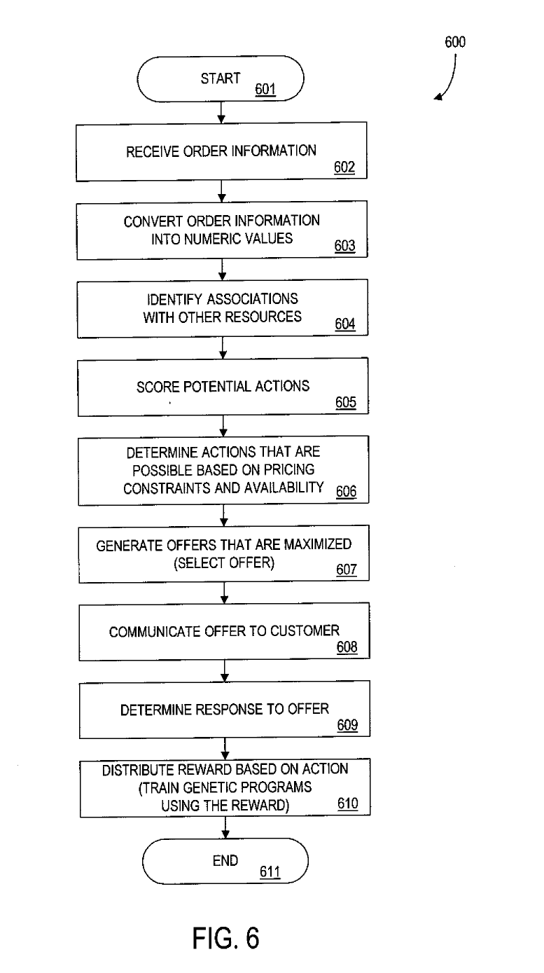

As seen from FIG. 2, the data storage device 30 24, which may comprise a hard disk drive, CD-ROM, DVD and/or semiconductor memory, stores a program 36. The program 36 is, at least in part, provided in accordance with the invention and controls the processor 28 to carry out functions which are described herein. The program 36 may also include other program elements, such as an operating system, database management system and “device drivers”, for allowing the processor 28 to perform known functions such as interface with peripheral devices (e.g., input devices 32, the communication port 34) in a manner known to those of skill in the art. Appropriate device drivers and other necessary program elements are known to those skilled in the art, and need not be described in detail herein. The storage device 30 may also store application programs and data that are not related to the functions described herein. One or more databases also may be stored in the data storage device 30, referred to generally as database 38. Exemplary databases that may be present within the data storage device 30 include a classifier database adapted to store classifiers as described below with reference to FIGS. 4 and 5, a genetic programs database adapted to store genetic programs as described below with reference to FIG. 6, an inventory database, a customer database and/or any other relevant database. Not all embodiments of the present invention require a server 24. That is, methods of the present invention may be performed by the POS terminals 22 themselves in a distributed and/or de-centralized manner.

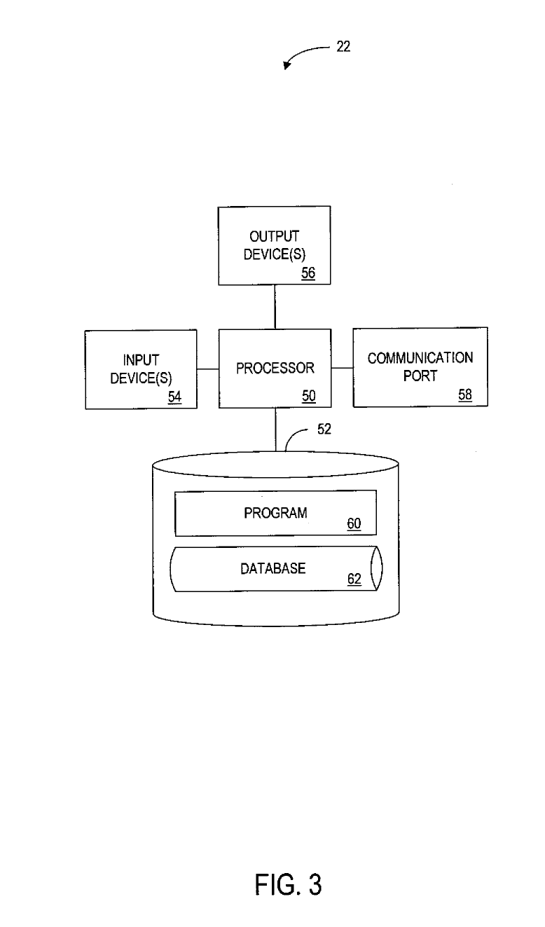

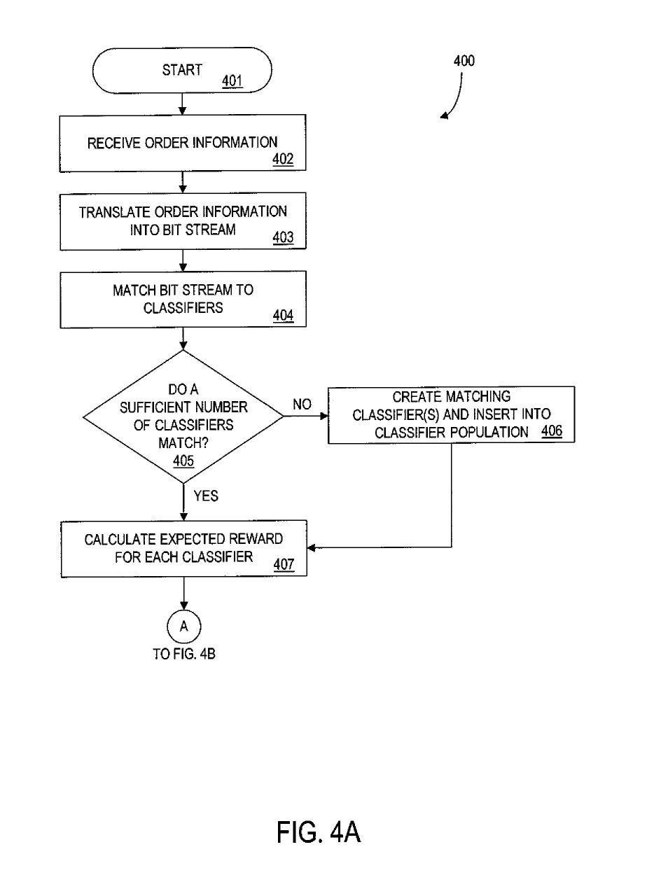

FIG. 3 illustrates in the form of a simplified block diagram a typical one of the POS terminals 22. The POS terminal 22 includes a processor 50 which may be a conventional microprocessor. The processor 50 is in communication with a data storage device 52 which may be constituted by one or more of semiconductor memory, a hard disk drive, or other conventional types of computer memory. The processor 50 and the storage device 52 may each be (i) located entirely within a single electronic device such as a cash register/terminal or other computing device; (ii) connected to each other by a remote communication medium such as a serial port, cable, telephone line or radio frequency transceiver or (iii) a combination thereof. For example, the POS terminal 22 may include one or more computers or processors that are connected to a remote server computer for maintaining databases.

Also operatively connected to the processor 50 are one or more input devices 54 which may include, for example, a key pad for transmitting input signals such as signals indicative of a purchase, to the processor 50. The input devices 54 may also include an optical bar code scanner for reading bar codes and transmitting signals indicative of the bar codes to the processor 50. Another type of input device 54 that may be included in the POS terminal 22 is a touch screen.

The POS terminal 22 further includes one or more output devices 56. The output devices 56 may include, for example, a printer for generating sales receipts, coupons and the like under the control of processor 50. The output devices 56 may also include a character or full screen display for providing text and/or other messages to customers and to the operator of the POS terminal (e.g., a cashier). The output devices 56 are in communication with, and are controlled by, the processor 50.

Also in communication with the processor 50 is a communication port 58 through which the POS terminal 22 may communicate with other components of the POS network 20, including the server 24 and/or other POS terminals 22.

As seen from FIG. 3, the storage device 52 stores a program 60. The program 60 is provided at least in part in accordance with the invention and controls the processor 50 to carry out functions in accordance with the teachings of the invention. The program 60 may also include other program elements, such as an operating system and “device drivers” for allowing the processor 50 to interface with peripheral devices such as the input devices 54, the output devices 56 and the communication port 58. Appropriate device drivers and other necessary program elements are known to those skilled in the art, and need not be described in detail herein. The storage device 52 may also store one or more application programs for carrying out conventional functions of POS terminal 22. Other programs and data not related to the functions described herein may also be stored in storage device 52. In a de-centralized embodiment of the invention, the storage device 52 may contain one or more of the previously described databases as represented generally by database 62 (e.g., a classifier database adapted to store classifiers as described below with reference to FIGS. 4 and 5, a genetic programs database adapted to store genetic programs as described below with reference to FIG. 6, an inventory database, a customer database and/or any other relevant database).

FIG. 4 is a flowchart of a first exemplary process 400 for generating rules and/or offers in accordance with the present invention. As described further below, the process 400 employs an extended classifier system (“XCS”) for rule/offer generation. Extended classifier systems are described in Wilson, “Classifier Fitness Based on Accuracy”, Evolutionary Computation, Vol. 3, No. 2, pp. 149-175 (1995).

Note that while the process 400 is described primarily with reference to the generation of rules/offers within a quick-service restaurant (“QSR”) such as McDonald's, Kentucky Fried Chicken, etc., it will be understood that the process 400 and the other processes described herein may be employed to generate rules/offers within any business setting (e.g., offers within a retail setting such as offers for clothing, groceries or other goods, offers for services, etc.). The process 400 and the other processes described herein may be embodied within software, hardware or a combination thereof, and each may comprise a computer program product. The process 400, for example, may be implemented via computer program code (e.g., written in C, C++, Java or any other computer language) that resides within the server 24 (e.g., within the data storage device 30) and/or within one or more of the POS terminals 22. In the embodiment described below, the process 400 comprises computer program code that resides within the server 24 (e.g., a server within a QSR that controls the offers made by the POS terminals 22 that reside within the QSR). This embodiment is merely exemplary of one of many embodiments of the invention.

With reference to FIG. 4, in step 401, the process 400 starts. In step 402, the server 24 receives order information. For example, a customer may visit a QSR that employs the server 24, and place an order at one of the POS terminals 22 (e.g., an order for a hamburger and fries); and the POS terminal 22 may communicate the order information to the server 24. The order information may include, for example, the items ordered by the customer (e.g., a hamburger, fries, etc.) or any other information (e.g., the identity of the customer, the time of day, the day of the week, the month of the year, the outside temperature, the identity of the cashier, destination information (e.g., eat in or take out) or any other information relevant to offer generation). Note that order information may be received from one or more POS terminals and/or from any other source (e.g., via a PDA of a customer, via an e-mail from a customer, via a telephone call, etc.) and may be based on data stored within the server 24 such as time of day, temperature, inventory or the like.

In step 403, the server 24 translates the order information into a bit stream (e.g., a binary bit stream or sequence of bits that represent the order information). For example, each ordered item identifier may be translated into a predetermined number and sequence of bits, and the bit sequence for all ordered item identifiers then may be appended together to form the bit stream. Other order information such as time of day, day of week, month of year, cashier identity, customer identity, destination (e.g., eat in or take out), temperature, etc., similarly may be converted into bit sequences and appended to the bit stream. Bit streams may be of any length (e.g., depending on the amount of order information, the bit sequence lengths employed, etc.). In one embodiment, a bit stream length of 960 bits is employed.

In one exemplary translation process, each item that may be ordered by a customer (e.g., each menu item), is broken down into its component parts (e.g., a hamburger equals beef, bread, sauce, etc.), each component part is assigned a bit sequence, and the bit sequence for the item is formed from a combination of the bit sequences of each component part of the item (e.g., beef=1, bread=4, sauce=32 so that the hamburger bit sequence equals 1+4+32=37 or 100101). Any other translation scheme may be similarly employed. To keep each bit stream uniform in length (e.g., to allow matching between bit streams and classifiers as described below), each order is assumed to comprise a predetermined number of items (e.g., six or some other number), and one or more null bit sequences may be employed within the bit stream if less than the number of pre-determined items are ordered.

Once a bit stream has been generated based on the order information (step 403), in step 404, the bit stream is matched to “classifiers” stored by the server 24 (e.g., classifiers stored within the database 38 of the data storage device 30). In at least one embodiment of the invention, each “classifier” comprises a “condition” and an “action” that is similar to an “if-then” rule. That is, if the condition is met (e.g., certain items are ordered on a certain day, at a certain time, by a certain customer, etc.), then the action is performed (e.g., a customer is offered an upsell offer, a dynamically-priced upsell offer, a suggestive sell offer, a switch-and-save offer, a cross-subsidy offer or any other offer). In the process 400 of FIG. 4, a bit steam is matched to a classifier by matching the bits of the bit stream with the bits of the classifier that represent the condition of the classifier. Methods for defining classifiers and for matching order information bit streams with classifiers are described in Appendix A herein. Note that matching may occur at the bit level, at the bit sequence level or at any other level.

In step 405, the server 24 determines if a sufficient number of classifiers have been matched to the bit stream (determined in step 403). For example, the server 24 may require that at least a minimum number of classifiers (e.g., ten) match the bit stream in order to search as much of the available offer space as possible). Note that each matching classifier need not have a unique action.

If a minimum number classifiers has not been matched to the bit stream, the process 400 proceeds to step 406 wherein additional matching classifiers are created (e.g., enough additional matching classifiers so that the minimum number of matching classifiers set by the server 24 is met); otherwise the process 400 proceeds to step 407. Additional matching classifiers may be created by any technique (see, for example, process 500 in FIG. 5), and may be added to the “population” of classifiers stored within the server 24 (e.g., by creating a new database record for each additional matching classifier, or by replacing non-matching classifiers with the additional matching classifiers). A “reward” associated with each additional classifier (described below with reference to step 407) may be determined based on, for example, a weighted average of the reward of each classifier already present within the server 24. Any other method may be employed to determine a reward for additional matching classifiers. Following step 406, the process 400 proceeds to step 407.

In step 407, the server 24 determines (e.g., calculates or otherwise identifies) an expected reward for each matching classifier (e.g., a predicted “payoff” of the action associated with the classifier). Rewards, predicted payoffs and other relevant factors in classifier selection are described further in Appendix A.

In step 408, the server 24 determines whether it should “explore” or “exploit” the matching classifiers. For example, if the server 24 wishes to explore customer response (e.g., take rate) to the actions associated with the matching classifiers (e.g., upsell, dynamically-priced upsell, suggestive sell, switch-and-save, cross-subsidy or other offers), the server 24 may select one of the actions of the matching classifiers at random (step 409). The server 24 may choose to “explore” for other reasons (e.g., to ensure that random actions/offers are communicated to cashiers that may be gaming or otherwise attempting to cheat the system 20). However, if the server 24 wishes to maximize profits, the server 24 may select the action of the matching classifier having the highest expected reward (step 410) given the current input conditions (e.g., order content, time of day, day of week, month of year, temperature, customer identity, cashier identity, weather, destination, etc.).

In step 411, the server 24 communicates the selected action to the relevant POS terminal 22 (e.g., the terminal from which the server 24 received the order information), and the POS terminal performs the action (e.g., makes an offer to the customer via the cashier, via a customer display device, etc.). In step 412, the server 24 determines the results of the selected action (e.g., whether the cashier made the offer to the customer, whether the customer accepted or rejected the offer, etc.) and generates a “reward” based on the result of the action. Rewards are described in further detail in Appendix A. Thereafter, in step 413, the server 24 updates the statistics of all classifiers identified in step 404 and/or in step 406 (see, for example, Appendix A). A classifier's statistics may be updated, for example, by updating the expected reward associated with the classifier. In step 414 the process ends.

Under certain circumstances, the server 24 may wish to introduce “new” classifiers to the population of classifiers stored within the server 24. For example, the server 24 may wish to introduce new classifiers to ensure that the classifiers being employed by the server 24 are the “best” classifiers for the server 24 (e.g., generate the most profits, increase customer traffic, have the best take rates, align offers with current promotions or advertising campaigns, promote new products, assist/facilitate inventory management and control, reduce cashier and/or customer gaming, drive sales growth, increase share holder/stock value and/or achieve any other goals or objective).

FIG. 5 is a flow chart of an exemplary process 500 for generating additional classifiers in accordance with the present invention. The process 500 may be performed at any time, on a random or a periodic basis. As with the process 400 of FIG. 4, the process 500 of FIG. 5 may be embodied as computer program code stored by the server 24 (e.g., in the data storage device 30) and may comprise, for example, a computer program product.

With reference to FIG. 5, the process 500 begins in step 501. In step 502, the server 24 selects two classifiers. The classifiers may be selected at random, may be selected because each has a high expected reward value, may be selected because the classifiers are part of a group of classifiers that match order information received by the server 24, and/or may be selected for any other reason. Thereafter, in step 503, a crossover operation is performed on the two classifiers so as to generate two “offspring” classifiers, and in step 504, each offspring classifier is mutated. Exemplary crossovers and mutations of classifiers are described further in Appendix A. An expected reward also may be generated for each offspring classifier (e.g., by taking a weighted average of other classifiers). In step 505, the offspring classifiers produced in step 504 are introduced into the classifier population of the server 24. For example, new database records may be generated for each offspring classifier, or one or more offspring classifiers may replace existing classifiers. In at least one embodiment, an offspring classifier is introduced in the classifier population only if the offspring classifier has a perceived value (e.g., an expected reward) that is higher than the classifier it replaces. In step 506, the process 500 ends.

Patent applications and patents incorporated by reference herein disclose, among other things, a dynamically-priced upsell module (DPL™) server for providing dynamically-priced upsell offers (e.g., “Digital Deal” offers) to POS terminals clients. Appendix A illustrates one embodiment of the present invention wherein the process 400 (FIG. 4), process 500 (FIG. 5) and/or XCS classifiers in general are implemented within a DPUM server. It will be understood that the present invention may be implemented in a separate server, with or without the DPUM server, and that Appendix A represents only one implementation of the present invention.

In addition to employing XCS techniques, the present invention also employs other evolutionary programming techniques for generating rules and/or offers. Appendix B illustrates one exemplary embodiment of employing Markov and Bayesian techniques with genetic programs for the generation of offers within a QSR (e.g., in association with a DPUM server). It will be understood that the evolutionary programming techniques and other methods described herein and in Appendix B may be employed to generate offers within any business setting (e.g., offers within a retail setting such as offers for clothing, groceries or other goods, offers for services, etc.).

FIG. 6 is a flowchart of a second exemplary process 600 for generating rules and/or offers in accordance with the present invention. The process 600 and the other processes described herein may be embodied within software, hardware or a combination thereof and each may comprise a computer program product. The process 600, for example, may be implemented via computer program code (e.g., written in C, C++, Java or any other computer language) that resides within the server 24 (e.g., within the data storage device 30) and/or within one or more of the POS terminals 22. In the embodiment described below, the process 600 comprises computer program code that resides within the server 24 (e.g., a server within a QSR that controls the offers made by the POS terminals 22 that reside within the QSR). This embodiment is merely exemplary of many embodiments of the invention.

With reference to FIG. 6, in step 601, the process 600 starts. In step 602, the server 24 receives order information. For example, a customer may visit a QSR that employs the server 24, and place an order at one of the POS terminals 22 (e.g., an order for a hamburger and fries); and the POS terminal 22 may communicate the order information to the server 24. The order information may include, for example, the items ordered by the customer (e.g., a hamburger, fries, etc.) or any other information (e.g., the identity of the customer, the time of day, the day of the week, the month of the year, the outside temperature or any information relevant to offer generation). Note that order information may be received from one or more POS terminals and/or from any other source (e.g., via a PDA of a customer, via an e-mail from a customer, via a telephone call, etc.) and may be based on data stored within server 24 such as time of day, temperature, inventory or the like.

In step 603, the server 24 converts the order information into numerical values. For example, environmental information (e.g., time of day, day of week, month of year, customer identity, cashier identity, etc.) and order item identifiers are each assigned a numeric value (see Appendix B). Thereafter, in step 604, based on the order information (e.g., using the numerical values associated with the order information as an input), the server 24 employs Markov and Bayesian principles to identify associations between ordered items and other items that may be sold to the customer. That is, the server 24 determines all items that may be offered to the customer based on the customer's order (and/or all actions that may be undertaken to offer items to the customer), and a “relevancy” of each item to the customer's order (e.g., a measure of whether the customer will accept an offer for the item).

In step 605, the server 24 scores the potential actions (e.g., offers) that the server may communicate to the POS terminal that transmitted the order information to the server 24 (e.g., all offers that may be made to the customer). In at least one embodiment, the server 24 scores the potential actions by assigning a numeric value to the relevancy of each item/action.

In step 606, the server 24 determines which actions/offers may/should be undertaken (e.g., which offers may/should be made to the customer). For example, the server 24 may choose to eliminate any actions that are not profitable (e.g., upselling an apple pie for one penny), that are impractical or unlikely to be accepted (e.g., offering a hamburger as part of a breakfast meal) or that are otherwise undesirable.

In step 607, the server 24 employs a genetic program to generate offers that are maximized (e.g., to pick the “best” action for the system 20). For example, the server 24 may generate offers/actions based on such considerations as relevancy, profit, discount percentage, preparation time, ongoing promotions, inventory, customer satisfaction or any other factors. Exemplary genetic programs and their use are described in more detail in Appendix B. In general, the server 24 may employ one or more genetic programs to generate offers/actions. In at least one embodiment, the server 24 employs numerous genetic programs (e.g., a hundred or more), and each genetic program is given an equal opportunity to generate offers/actions (e.g., based on a random selection, a “round robin” selection, etc.). In other embodiments, a weighted average scheme may be employed for offer/action generation (e.g., offers/actions may be generated based on a weighted average of one or more business objectives such as generating the most profits, increasing customer traffic, having the best take rates, aligning offers with current promotions or advertising campaigns, promoting new products, assisting/facilitating inventory management and control, reducing cashier and/or customer gaming, driving sales growth, increasing share holder/stock value, promoting offer deal values that are less than a dollar or more than a dollar, etc., based on various factors such as acceptance/take rate, average check information (e.g., to mitigate customer and/or cashier gaming), cashier information (e.g., how well a cashier makes certain offers) and/or based on any other goals, objectives or information). Filters and/or other sort criteria similarly may be employed. Note that weighting, filtering and/or sorting schemes also may be employed during the explore/exploit selection processes described previously with reference to FIG. 4 and process 400.

In step 608, the server 24 communicates the offer (or offers) to the relevant POS terminal 22, which in turn communicates the offer (or offers) to the customer (e.g., via a cashier, via a customer display device, etc.). Thereafter, in step 609, the server 24 determines the customer's response to the offer (e.g., assuming the cashier communicated the offer to the customer, whether the offer was accepted or rejected). Note that whether or not a cashier communicates an offer to a customer may be determined employing voice recognition technology as described in previously incorporated U.S. patent application Ser. No. 09/135,179, filed Aug. 17, 1998, or by any other method. For example, it has been discovered that the time delay between when an offer is presented to a customer and when the offer is accepted by the customer may indicate that a cashier is gaming (e.g., if the time delay is too small, the cashier may not have presented the offer to the customer, and the cashier may have charged the customer full price for an upsell and kept any discount amount achievable from the offer).

In step 610, the server 24 trains the genetic programs stored by the server 24 based on the results of the whether the offer was made by the cashier, accepted by the customer or rejected by the customer (e.g., the server 24 “distributes the reward”). Exemplary reward distributions are described in more detail in Appendix B. In step 611, the process 600 ends.

As with the XCS techniques described with reference to FIG. 4 and Appendix A, new genetic programs may be created using crossover, replication and mutation processes. For example, a new population of genetic programs (e.g., offspring genetic programs) may be generated by “mating” (e.g., via crossover) two genetic programs, by replicating an existing genetic program and/or by mutating an existing genetic program or offspring genetic program. Selection of “parent” genetic programs may be based on, for example, the success (e.g., “fitness” described in Appendix B) of the parent genetic programs. Other criteria may also be employed.

In at least one embodiment of the invention, a separate Markov distribution and a separate Bayesian distribution may be maintained for recent transactions and for cumulative transactions, and the server 24 may combine the recent transaction and cumulative transaction distributions (e.g., when making genetic program generation decisions). During promotions, the server 24 may choose to weight the recent transaction distributions heavier than the cumulative transaction distributions (e.g., to increase the response time of the system to promotional offers).

The foregoing description discloses only exemplary embodiments of the invention, modifications of the above disclosed apparatus and method which fall within the scope of the invention will be readily apparent to those of ordinary skill in the art. For instance, the process 400 and/or the process 600 initially may be run in the background at a store or restaurant to “train” the server 24. In this manner, the server 24 (via the process 400 and/or the process 600) may automatically learn the resource distributions and resource associations of the store/restaurant through observation using unsupervised learning methods. This may allow, for example, a system (e.g., the server 24, an upsell optimization system, etc.) to participate in an industrial domain, brand, or store/restaurant without prior knowledge representation. As transactions are observed, the performance increases correspondingly. This observation mode (or “self-learning” mode) may allow the system to capture transaction events and update the weights associated with a neural network until the system has been sufficiently trained. The system may then indicate that it is ready to operate and/or turn itself on.

Other factors may be employed during offer/rule generation. For example, either the process 400 or the process 600 may be employed to decide whether an item should be sold now or in the future (e.g., based on inventory considerations, based on the probability of the item selling later, based on replacement costs, based on one or more other business objectives such as generating the most profits, increasing customer traffic, having the best take rates, aligning offers with current promotions or advertising campaigns, promoting new products, reducing cashier and/or customer gaming, driving sales growth, increasing share holder/stock value, promoting offer deal values that are less than a dollar or more than a dollar, etc., based on various factors such as acceptance/take rate, average check information (e.g., to mitigate customer and/or cashier gaming), cashier information (e.g., how well a cashier makes offers) and/or based on any other goals, objectives or information).

Note that the genetic programming described herein may be employed to automatically create upsell optimization strategies evaluated by business attributes such as profitably and accept rate. Because this is independent of a particular retail sector, this knowledge can be shared universally with other implementations of the present invention operated in other domains (e.g., upsell optimization strategies developed in a QSR may be employed within other industries such as in other retail settings). Particular buying habits and tendencies may be ‘abstracted’ and used by other business segments. That is, genetic programs and processes from one business segment can be adapted to other business segments. For example, the process 400 and/or the process 600 could be used within a retail clothing store to aid cashiers/salespeople in making relevant recommendations to compliment a given customer's initial selections. If a customer selected a shirt and pair of slacks, the system 20 might recommend a pair of socks, shoes, tie, sport coat, etc., depending upon the total purchase price of the ‘base’ items, time of day, day of week, customer ID, etc. Thereafter, the genetic programs employed by the system 20 in the retail clothing setting can be used across industries (e.g., genetic programs may evolve over time into a more efficient application). Therefore, although a given set of rules may or may not apply in another industry a given ‘program’ may have generic usefulness in other retail segments when applied to new transactional data and/or rule sets (manually or genetically generated).

In some embodiments of the invention, unsupervised and reinforcement learning techniques may be combined to automatically learn associations between resources, and to automatically generate optimized strategies. For example, by disentangling a resource learning module from an upsell maximizing module, relevant, universal information may be shared across any retail outlet. Additionally, a reward can be specified dynamically with respect to time, and independently of a domain. Through the use of rewards (e.g., feedback), a “self-tuning” environment may be created, wherein successful transactions (offers), are propagated, while unsuccessful transactions are either discouraged and/or wither and die out. Note that rewards may also be provided to a cashier for successfully consummating an offer (e.g., if a customer accepts the reward), or for simply making offers (e.g., using voice technologies to track cashier compliance). The process 400 and/or the process 600 may be used to automatically determine (e.g., generally for all cashiers and/or specifically for individual cashiers) which incentive programs are most productive for motivating cashiers (e.g., either for a program as a whole or targeted incentives by transaction). For example, the present invention may be employed to determine that a cash based incentive for an entire team is more effective, on average, than individual incentives (or vice versa). However, it may also be determined that an additional individual incentive is particularly effective when the amount of sale exceeds a certain dollar amount (e.g. $20.00).

In one or more embodiments, the present invention may be employed to automatically determine the various pricing levels within a retail outlet that has implemented a tiered pricing system, such as the tiered pricing system described in previously incorporated U.S. Pat. No. 6,119,100. For example, the system 20 may be employed to determine the number (e.g., 2, 3 . . . n), timing and levels of various pricing schemes. Based on consumer behaviors, the system 20 could become “self-tuning” using one or more of the methods described herein.

In at least one embodiment, the present invention may be employed to translate classifiers into “English” (or some other human-readable language). For example, humans (e.g., developers) may wish to understand the operation of the present invention by analyzing its processes and underlying assumptions (e.g., via the examination of classifiers). In this regard, a translation module (e.g., computer program code written in any computer language) may be employed that translates classifiers into a human readable form.

Accordingly, while the present invention has been disclosed in connection with the exemplary embodiments thereof, it should be understood that other embodiments may fall within the spirit and scope of the invention as defined by the following claims.

### Appendix A

### Purpose

This Appendix A describes the XCS Algorithm and offers a scheme for adopting it to optimize the Digital Deal rules.

### Overview of Classifier Systems

A classifier system is a machine learning system that uses “if-then” rules, called classifiers, to react to and learn about its environment. Machine learning means that the behavior of the system improves over time, through interaction with the environment. The basic idea is that good behavior is positively reinforced and bad behavior is negatively reinforced. The population of classifiers represents the system's knowledge about the environment.

A classifier system generally has three parts: the performance system, the learning system and the rule discovery system. The performance system is responsible for reacting to the environment. When an input is received from the environment, the performance system searches the population of classifiers for a classifier whose “if” matches the input. When a match is found, the “then” of the matching classifier is returned to the environment. The environment performs the action indicated by the “then” and returns a scalar reward to the classifier system.

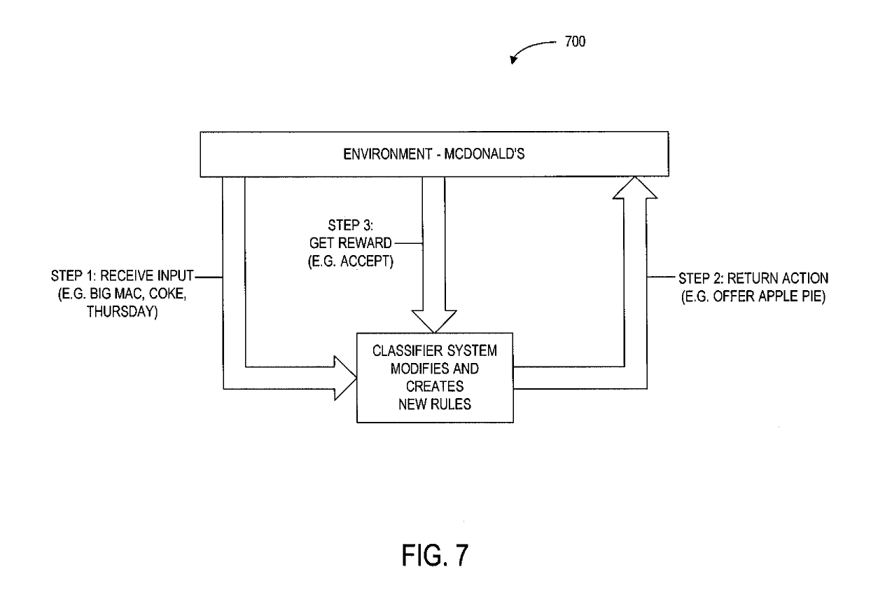

FIG. 7 generally illustrates one embodiment 700 of a classifier system.

One should note that the performance system is not adaptive; it just reacts to the environment. It is the job of the learning system to use the reward to reevaluate the usefulness of the matching classifier. Each classifier is assigned a strength that is a measure of how useful the classifier has been in the past. The system learns by modifying the measure of strength for each of its classifiers. When the environment sends a positive reward then the strength of the matching classifier is increased and vice versa.

This measure of strength is used for two purposes. When the system is presented with an input that matches more than one classifier in the population, the action of the classifier with the highest strength will be selected. The system has “learned” which classifiers are better. The other use of strength is employed by the classifier system's third part, the rule discovery system. If the system does not try new actions on a regular basis then it will stagnate. The rule discovery system uses a simple genetic algorithm with the strength of the classifiers as the fitness function to select two classifiers to crossover and mutate to create two new and, hopefully, better classifiers. Classifiers with a higher strength have a higher probability of being selected for reproduction.

### Overview of XCS

XCS is a kind of classifier system. There are two major differences between XCS and traditional classifier systems:
1. As mentioned above, each classifier has a strength parameter that measures how useful the classifier has been in the past. In traditional classifier systems, this strength parameter is commonly referred to as the predicted payoff and is the reward that the classifier expects to receive if its action is executed. The predicted payoff is used to select classifiers to return actions to the environment and also to select classifiers for reproduction. In XCS, the predicted payoff is also used to select classifiers for returning actions but it is not used to select classifiers for reproduction. To select classifiers for reproduction and for deletion, XCS uses a fitness measure that is based on the accuracy of the classifier's predictions. The advantage to this scheme is that since classifiers can exist in different environmental niches that have different payoff levels and if we just use predicted payoff to select classifiers for reproduction then our population will be dominated by classifiers from the niche with the highest payoff giving an inaccurate mapping of the solution space.
2. The other difference is that traditional classifier systems run the genetic algorithm on the entire population while XCS uses a niche genetic algorithm. During the course of the XCS algorithm, subsets of classifiers are created. All classifiers in the subsets have conditions that match a given input. The genetic algorithm is run on these smaller subsets. In addition, the classifiers that are selected for mutation are mutated in such a way so that after mutation the condition still matches the input.

### XCS Classifiers

A Classifier is an “if-then” rule composed of 3 parts: the “if”, the “then” and some statistics. The “if” part of a classifier is called the condition and is represented by a ternary bitstring composed from the set {0, 1, #}. The “#” is called a Don't Care and can be matched to either a 1 or a 0. The “then” part of a classifier is called the action and is also a bitstring but it is composed from the set {0, 1}. There are a few more statistics (see table below) in addition to the Predicted Payoff and Fitness that were mentioned above.

Example of a Classifier:

0#011#01##000011#1 [symbol] 011010

The condition (the left-side of the arrow) could translate to something like “If its Thursday or Tuesday at noon and the order is a Big Mac and Soda.”

The action (the right-side of the arrow) could translate to something like “Offer an ice cream cone.”

Classifier Matching

It was stated above that the population of classifiers is searched for classifiers that match the input. How does a classifier match an input? First, the input from the environment (like Big Mac and Coke) is encoded as a string of 0's and 1's. A classifier is said to match an input if: 1. The condition length and input length are equal 2. For every bit in the condition, the bit is either a # or it is the same as the corresponding bit in the input. For example, if the input is “Thursday, noon, Big Mac, Soda” then there might be a classifier that has a Don't Care for the day of the week. If there is such a classifier then it would match the input if it also has “noon, Big Mac, Soda” in the condition.

Example of Matching:

Let the input from the environment be:

I: 001010011 (Could mean something like: Thursday, 1:00 pm, Cashier 2, Store 10, 2 Big Macs, 1 Large Coke)

Let the population of classifiers be:

C1: 01##110## [symbol] 0110

C2: #010#001# [symbol] 1000

C3: 0#1#100## [symbol] 0111

C4: 0#111#0#0 [symbol] 0110

C5: 00#1000#0 [symbol] 0010

C6: 0#0100## [symbol] 0001

I matches C2, C3, C6.

Classifier Statistics

The following table 1 lists the statistics that each classifier keeps along with the algorithm for updating the statistics after a reward has been received from the environment.

TABLE 1

| | | UPDATE ALGORITHM |
|---|---|---|
| | | Let L be the Learning Rate |
| | | Let R be the Reward received |
| | | The “If ( experience < 1/L )” is the |
| STATISTIC | DESCRIPTION | implementation of the MAM technique |
| Prediction | Keeps an average of the expected | If ( experience <=1/L ) |
| | payoff if the classifier matches the | pred = (pred * experience + R) / |
| | input and its action is taken. Note | (experience + 1) |
| | that fitness is used to select | Else |
| | classifiers for reproduction only. | pred = pred + L * ( R − pred ) |
| | Prediction is used to define which | |
| | is the “best” classifier. | |
| Error | Estimates the errors made in the | If ( experience <= 1/L ) |
| | prediction. | error = (error * experience + |
| | | ( \| R − pred \| / paymentRange)) / |
| | | (experience + 1) |
| | | Else |
| | | error = error + ( L * |
| | | ((\| R − pred \| / paymentRange) − error)) |
| Fitness | The fitness of the classifier is based | First, calculate the total accuracy for all |
| | on the accuracy of the classifier's | classifiers in the action set. |
| | predictions. Note that fitness | TotalAccuracy TA = |
| | increases as error decreases. Note | □_{c in Action Set} (numerosity_{c} * Accuracy_{c}) |
| | that fitness is used to select | Second, compute relative accuracy, RA. |
| | classifiers for reproduction only. | RA = (accuracy * numerosity) / TA. |
| | Prediction is used to define which | Then, compute fitness. |
| | is the “best” classifier. | fitness = fitness + L * (RA − fitness) |
| Experience | The number of times since its | Increment By 1 |
| | creation that a classifier has | |
| | belonged to an action set. | |
| GA Iteration | Denotes the time-step of the last | Set to current iteration |
| | occurrence of a GA in an action set | |
| | to which this classifier belonged. | |
| Action Set Size | Estimates the average size of the | If ( experience <= 1/L ) |
| | action sets this classifier has | size = size + |
| | belonged to. Updates to this are | ( □_{c in Action Set} numerosity_{c} − size ) / |
| | independent of updates to fitness, | experience |
| | error and prediction. | Else |
| | | size = size + |
| | | L * ( □_{c in Action Set} numerosity_{c} − size ) |
| Numerosity | Is the number of microclassifiers | Incremented when a classifier subsumes |
| | that are represented by this | another classifier and when an identical |
| | classifier, | classifier is created. Decremented when a |
| | | classifier is deleted from the population. If |
| | | numerosity equals 0 then the classifier is |
| | | deleted from the population. |
| Accuracy | This is a measure of how accurate a | Let E be the minimum error |
| | classifier's predictions are. This can | If ( error <= E ) |
| | be computed from error so it does | Accuracy = 1.0 |
| | not need to be stored. | Else |
| | | Accuracy = |
| | | e ^{((In (fallOffRate) * (error - E)/E)} * fallOffRate |
| | | Note: fallOffRate < 1 => In(fallOffRate) < 0 |
| | | error > E => error − E > 0 |
| | | e raised to a negative power is a number |
| | | in (0,1) so Accuracy becomes some |
| | | number between (0,1) |

Input Covering—Generation of Matching Classifiers

When an input is received, the population of classifiers is searched and all matching classifiers are put in a set called the Condition Match Set. If the size of the Condition Match Set is less than some number N then the input is not covered. The number N is known, appropriately enough, as the Minimum Match Set Size and is a parameter of the system. To cover an input, matching classifiers are created and inserted into the population.

The algorithm for creating matching classifiers is as follows:
1. Initialize the classifier, CL, so that its condition identically matches the input.
2. For each bit in CL: Generate a random number, R, in [0,1]. If (R<Covering Probability) then change the bit to a ‘#’. Covering Probability is also a parameter of the system.
3. Generate a random action that is not present in the Condition Match Set.
4. Set the prediction equal to the mean prediction of all classifiers in the population.
5. Set the error equal to the mean error of all classifiers in the population.
6. Set the fitness equal to the 0.1*mean fitness of all classifiers in the population.
7. Set the experience equal to 0
8. Set the GA iteration equal to the current iteration.
9. Set the action set size equal to the mean action set size.
10. Set the numerosity equal to 1
11. Insert CL into the population and into the Condition Match Set

### Digital Deal Classifiers

Digital Deal classifiers are just like regular XCS classifiers except that they have special requirements for matching, covering and random action generation. Both the condition and action contain Menu Item Ids. These are used to look up the item in the Digital Deal menu item database in order to get pricing and cost information. The Digital Deal classifiers are stored in the DPUM database.

Condition

The condition in a Digital Deal classifier is 3 64 bit chunks for the environment and 6 128-bit chunks for the food items. The environment contains things like day-of-week, time-of-day, cashier id, store id, etc. Calling the right-most bit the 0^{th} bit, the following table 2A defines the bit locations of each field in the environment:

TABLE 2A

| Bits | Field | Len |
|---|---|---|
| 0-32 | Destination ID from DPUM database | 33* |
| 33-44 | Month (Jan => 1, Feb => 2, Mar => 4, etc) of | 12 |
| | Order | |
| 45-49 | Time of Order - Hour | 5 |
| 64-96 | Period ID from DPUM database | 33* |
| 97-103 | Day Of Week (Sunday => 1, Monday => 2, | 7 |
| | Tuesday => 4, etc) | |
| 128-159 | Register ID from DPUM database | 32 |
| 160-191 | Cashier ID from DPUM database | 32 |

*MSB is the sign bit, if set then the quantity in the remaining bits is negative

Each of the next 6 128-bit chunks defines a menu item. Calling the right-most bit the 0^{th} bit, the following chart defines the bit locations of each property of a menu item:

TABLE 2B

| Bits | Property Name | Len |
|---|---|---|
| 0-11 | Menu Item Type | 12 |
| 12-23 | Size | 12 |
| 24-35 | Temperature | 12 |
| 36 | Pre-packaged | 1 |
| 37 | Discounted | 1 |
| 38-43 | Time Of Day Available | 6 |
| 64-127 | Specific Properties for Type | 64 |

The exact values for the Property Name column are defined in Appendix A-2.

Action

An action has a variable length. The length depends on the type of action and the length of the binary descriptions of the menu items in the action. The shortest possible length of an action is 3*64 bits and the length will always be a multiple of 3.

An action is composed of groups of 3 64-bit chunks. The first chunk contains the 32-bit Menu Item Id from the DPUM database and the next 128-bits contain the binary description of that menu item. If the item is a meal then it will need more than one 128-bit chunk for the description so append the additional 128-bit description with a pad of 64 0's between each 128-bit description.

If the action is a Replace then the first Menu Item Id is the Id of the item to replace and the second Menu Item Id is the Id of the offer. If the action is an Add then there will only be one Menu Item Id in the action. Additionally, the MSB of the first 64-bit chunk will be set if the action is a Replace.

Digital Deal Classifier Matching

Before an order is sent to the XCS system, it is broken up into separate meals. Exactly how the order is broken up is discussed later but here is an example: Let the order be 1 Big Mac, 1 Hamburger, 2 Large Fries, 1 Coke, 1 Apple Pie then the possible meals are M1=(Big Mac, Large Fries, Coke, null, null, null) and M2=(Hamburger, Large Fries, Apple Pie, null, null, null). A meal contains 6 menu items. Some of the menu items may by null. A menu item belongs to one of 6 classes: main, side, beverage, dessert, miscellaneous, topping/condiment. A meal may have more than one kind of menu item in it (e.g., it is ok for a meal to have 2 sides). The input that we are matching against is actually a meal and not an entire order.

With all of that in mind, for a classifier, C, to match a given input, I, then all of the following must be true:
1. The environments of I and C must match. The first 192 bits of C and of I are the environment. Use traditional bit-by-bit matching to match the two environments.
2. Use traditional bit-by-bit matching to match the menu items. For each menu item in the input, there must be a matching menu item in the classifier Order does not matter. The first item in the input can match, say, the third item in the classifier.
3. The action must match the input. For example, if the input is “Big Mac and Soda” then the action cannot be “Replace the small coffee with a large coffee.”
4. The amount of change must be less than the price of the offer. For example, if the total price of the order is $2.01 then the change is $0.99 and if the price of the offer in the action is $0.50 then this is not a match. This classifier could have been created for an order with a total price of something like $2.60 so that the action with a price of $0.50 made more sense.
   Digital Deal Random Action Generation

The process of generating random Digital Deal actions may seem like a trivial task but is quite complicated. The chief culprit is the desire for the random actions to be very random. By “very” random, I mean that the search space of all possible actions is quite large so the random actions should cover as much of it as possible. The other major problem is that the random actions are subject to a whole slew of constraints. The actions generated should be profitable to both the store and the customer. For example, an offer that is not profitable to the store is “For your change of $0.05, add 20 Big Macs” and an offer that is not profitable to the customer is “For your change of $0.30, you can replace your Super-Size soda with a small Soda.” Remember that the order is broken up into meals so random actions are generated per meal.

The following is a step-by-step explanation of how random actions can be generated.
1. Let TP be the total price of the entire order (not just the meal).
2. Let T be the time of day that the offer is valid (e.g., the Period ID of the order).
3. Initialize O, the set of possible offers, to the empty set.
4. With equal probability, randomly decide if the offer will be a replace or an add.
5. If the offer is a replace then randomly pick something from the meal to replace. The item can be replaced if it's parent item is null and it's min and max price are >0.
6. Let TP_{round} be TP rounded up to the next dollar.
7. Compute the amount of change available by subtracting TP from TP_{round}.
8. If the offer is an add then add all menu items that satisfy the following to O: the item is for the presently described embodiment of the invention, the min price is less than the change, the max price is greater than the change and the item is available in time period T. If the offer is a replace then add all menu items that satisfy the following to O: the item is for the presently described embodiment of the invention, the price of the item is greater than the price of the replaced item, the (min price—min price of replaced) is less than the change, the (max price—max price of replaced) is greater than the change and the item is available in time period T. For a replace, we have to check both price and max price since the max price of an item may be 0 if it is not available as an offer.
9. If the size of the set O generated in Step 8 is less than half the size of the minimum match set size (M) then add $1 to the change and return to Step 8 to try to add more items to O. By making the size of the offer pool greater than M, as opposed to just greater than 0, we are guaranteed to have more random actions.
10. If the set O is not empty then randomly select one of the items and return it. If the set is empty and the offer is a replace then switch the offer to an add and go to step 8. If the set is empty and the offer is an add then return null; no offer will be generated for this order.

### XCS System Parameters

The following TABLE 3 lists the system parameters for the XCS algorithm. An application with a graphical interface may be built to allow an expert user to change these parameters. The given defaults are the defaults recommended by the designer of the XCS algorithm (see Wilson 1995 referenced above).

TABLE 3

| PARAMETER | DESCRIPTION | COMMON SETTING | DEFAULT |
|---|---|---|---|
| Population | Number of classifiers in the | This should be large enough so | 5000 |
| Size | system | that covering only occurs at the | |
| | | very beginning of a run. | |
| Action Space | The number of possible actions | It must be greater than the | 85 |
| Size | in the system. | minimum match set size. | |
| Initial | The initial classifier prediction | Very small in proportion to the | 10 |
| Prediction | value used when a classifier is | maximum reward. For a | |
| | created through covering. | maximum reward of 1000, a | |
| | | good value for this is 10. | |
| Initial Fitness | The initial classifier fitness value | 0.01 | 0.01 |
| | used when a classifier is created | | |
| | through covering. | | |
| Initial | The initial classifier accuracy | 0.01 | 0.01 |
| Accuracy | value used when a classifier is | | |
| | created through covering. | | |
| Initial Error | The initial classifier error value | Should be small | 0 |
| | used when a classifier is created | | |
| | through covering. | | |
| Crossover | The probability of crossover | Range of 0.5-1.0 | 0.8 |
| Probability | within the GA | | |
| Mutation | The likelihood of a bit being | Range of 0.01-0.05 | 0.04 |
| Probability | mutated | | |
| Minimum | The minimal number of | To cause covering to provide | 10 |
| Match Set Size | classifiers in the match set that | classifiers for every action then | |
| | must be present or covering will | set this equal to the number of | |
| | take place | available actions. | |
| GA Threshold | The GA is applied in a set when | Range 25-50 | 25 |
| | the average time since the last | | |
| | GA is greater than this threshold. | | |
| | Each classifier keeps track of a | | |
| | time stamp that indicates the last | | |
| | time that a GA was run on an | | |
| | action set that it belonged to. | | |
| | The time stamp is in units of | | |
| | “steps.” | | |
| Covering | The probability of using a ‘#’ | 0.33 | 0.33 |
| Probability | symbol in a bit during covering. | | |
| Learning Rate | The learning rate for Prediction, | 0.1-0.2 | 0.2 |
| | Error and Fitness. Used to | | |
| | implement the MAM technique. | | |
| Deletion | If the experience of a classifier is | 20 | 20 |
| Threshold | greater than this then the fitness | | |
| | of the classifier may be | | |
| | considered in its probability of | | |
| | deletion. | | |
| Exploration | The probability that during | 0.5 | 0.5 |
| Probability | action selection the action will | | |
| | be chosen randomly. | | |
| Minimum | The error below which | 0.01 | 0.01 |
| Error | classifiers are considered to have | | |
| | equal accuracy. Used to update | | |
| | the fitness. | | |
| Fall Off Rate | Used to update the accuracy | 0.1 | 0.1 |
| Subsumption | The experience of a classifier | 20 | 20 |
| Threshold | must be greater than this in order | | |
| | to be able to subsume another | | |
| | classifier. | | |
| Mean Fitness | Specifies the mean fitness in the | 0.1 | 0.1 |
| Fraction | population below which the | | |
| | fitness of a classifier may be | | |
| | considered in its probability of | | |
| | deletion. | | |
| Minimum | The reward for a bad action. | 0 | 0 |
| Reward | | | |
| Maximum | The reward for a good action. | 1000 | 1000 |
| Reward | | | |
| Action Set | Action Set Subsumption can be | True | True |
| Subsumption | turned on/off by toggling this | | |
| Flag | flag. | | |
| GA | GA Subsumption can be turned | True | True |
| Subsumption | on/off by toggling this flag. | | |
| Flag | | | |

### Single-Step XCS Algorithm

1. Let O be the order (For example, 1 KFC Meal (Chicken Leg, Cole Slaw, Beans), 1 Chicken Sandwich, 1 Soda, and an Apple Pie). Let C be the population of classifiers.
2. Break O into meals M₁, M₂, M₃, . . . M_{N}
   a. Shuffle the order of the items in the order
   b. For each item in the order, find the item in the Menu Item table. If the item cannot be found and the item's parent is null then reject the entire order and return no offer. If the item cannot be found but it's parent is non-null then just skip the item. If the item is of type Meal (like a Extra Value Meal) then add it to a unique Mᵢ. If the item is not of type Meal then place it into a separate list. After all the items in the order have been inspected, scroll through the list of single type items and add those to the recently created Mᵢ or create new Mᵢ.
For the example order above the possible meals are:
M₁=Chicken Leg, Cole Slaw, Beans, Apple Pie, null, null
M₂=Chicken Sandwich, Soda, null, null, null
3. For each Meal in the order, generate Condition Match Sets. Create a Condition Match Set by searching through the population for any classifiers that match the given Meal.
4. If the size of any Condition Match Set is less than the Minimum Match Set Size then cover the Meal. See the sections on Classifiers and Digital Deal Classifiers for an explanation of covering.
5. For all the Condition Match Sets, create a Prediction Array. The Prediction Array stores the predicted payoff for each possible action in the system. The predicted payoff is a fitness-weighted average of the predictions of all classifiers in the Condition Match Set that advocate the action. The formula for calculating the fitness-weighted averages is: Let AS be the set of classifiers from the Condition Match Set with the same action, A. Then the Predicted Payoff, P, of A is:

$$P = ( {\sum }_{c ∈ AS} {Prediction}_{c} * {Fitness}_{c} ) / {\sum }_{c ∈ AS} {Fitness}_{c}$$
6. If possible, choose 2 actions. The actions can be either a random selection (exploration) or based upon the Prediction Array (exploitation). If exploration then choose 2 random actions. If exploitation then choose the 2 best actions. The best action is defined to be the action with the highest prediction. If the highest prediction is shared by two or more actions then randomly choose an action.
7. Create an Action Set for each chosen action. The Action Set is the set of classifiers from the Condition Match Set that have actions that match the chosen action. The Genetic Algorithm is run only on the Action Set.
8. Return the actions to the environment. The amount of the reward is based on whether the offer was rejected or accepted. The reward is 0 if the offer was rejected. If the offer was accepted then the amount of the award is (1−minprice of offer/change in order)*100 rounded to the nearest integer and then divided by 10. This gives rewards in the set {1000, 1100, 1200, . . . , 2000}. This reward scheme gives accepted offers with bigger profits a higher reward. Since two offers are returned, the accepted offer is given a positive reward while the other offer is given a negative reward.
9. Using the reward, update all the statistics of the classifiers that are part of Action Set. The statistics are modified in the following order: experience, action set size prediction, error, accuracy and fitness. Changing the order of the modifications will change the rate at which the system learns. For example, if prediction comes before error then the prediction of a classifier in its very first update immediately predicts the correct payoff and consequently the prediction error is set to 0. This can lead to faster learning in simple processes but can be misleading in more complex problems. The algorithms for updating the statistics are given in a table above.Do Action Set Subsumption if it is enabled. In Action Set Subsumption, the Action Set is searched for the most general classifier that is both accurate and sufficiently experienced. All other classifiers in the set are tested against this general one to see if it subsumes them. Any classifiers that are subsumed are removed from the population. Example: Let the Action Set be:C1: 011#110## →0111 C2: #010#001#→0111 C3: #0#1#1#0##→0111 C4: 0#111#0#0→0111. C3 is the most general since it has the most #'s. It is more general than C1 and C4. It is not more general than C2 since C2 has a ‘#’ in the first position and C3 does not. If C3 is accurate and sufficiently experienced then we could subsume C1 & C4 by removing them from the population and increasing the numerosity of C3 by 2.
11. Run the Genetic Algorithm (GA) if the Action Set indicates that we should. The GA will be run on the Action Set if the average time since the last GA in the set is greater than the GA threshold. Average time, AT, is computed as follows: AT=□□□□GA iteration_{cl}*numerosity_{cl}□□□□□□□numerosity_{cl}) where the □ is over the Action Set. To run the GA, use Roulette Wheel Selection to select two parents from the Action Set. By using Roulette Wheel selection, the classifiers with the highest accuracy tend to reproduce most often. Using the probability of crossover, the parents are crossed. If the parents are crossed then the prediction values of the offspring are set to the average of the prediction values of the parents. Notice that crossover only takes place in the condition and not in the action. Next, mutate the two offspring. Mutation takes place in both the action and the condition. XCS uses a restricted version of mutation that only allows a bit of the condition to be mutated if it is changed to a ‘#’ or to a value that matches the given input. This results in an offspring with a condition that still matches the input. Actions are mutated as a whole (e.g., actions are mutated into a randomly generated new action). Now that we have two new offspring, check if its parent subsumes either offspring. The parent must have an experience level greater than the Subsumption Threshold and must be accurate (accuracy of 1.0). If the offspring is subsumed then do not insert it into the population, just increment the numerosity of the parent. If the offspring is not subsumed then it is inserted to the population. If the size of the population is greater than the maximum size then a classifier has to be selected for deletion. XCS uses Roulette Wheel Selection to select a classifier for deletion.

### Organization of the Software

The code is organized into two parts: the Classifier System and Digital Deal Classifier. The Classifier System is a black box that receives a vector of bitstrings, runs the XCS algorithm on them, produces an action and receives rewards. It knows nothing about Digital Deal, QSR, Big Macs, upsells, etc. The Classifier System contains an abstract object called Classifier. When the Classifier System is created, it is passed the name of a classifier class. This classifier class encapsulates all of the peculiarities of the problem at hand. Through the power of inheritance, the Classifier System black box can manipulate Digital Deal classifiers or any other kind of classifier. The Digital Deal Classifier module supplies all the special routines for matching and generating random actions that were discussed above.

Classifier System

SystermParameters

Each environment must create a SystemParameters class using the function SystemParameters.createSystemParameters. This function verifies that the parameters are valid and then creates and returns a reference to a SystemParameters class. If the parameters are invalid then an exception is thrown. This function takes a String argument. If the argument is null then the default system parameters are used. If the argument is not null then it must be the name of a SystemParameters class. A reference to the parameters class is passed to the ClassifierSystem when it is created. To change the defaults:
1. Derive a SystemParameters class from SystemParameters. Implement the function localDefaultValues to add new defaults values.
2. Pass the name of this new class to the function SystemParameters.createSystemParameters.
   Additional parameters can be added in a similar way.
   BitString

A BitString is a class containing an array of longs. In Java, longs are 64-bits long. When a BitString is created with just a length then:
1. Figure out how many 64-bit chunks are needed to contain that length. Example if length=65 then 2 64-bit chunks are needed.
2. Initialize the array of longs to have a length equal to the number of chunks that was computed in 1.
3. Initialize each element of the array to 0.

When a BitString is created with a String argument then:
1. Do the same as above using length=string length.

2. If the i-th character of the string is a ‘1’ then figure out which bit in which chunk maps to i and set it to a 1. The mapping is from 1-Dimension to 2-Dimensions and is given in TABLE 4 below.

TABLE 4

| String Index | Array Index | Bit of Long |
|---|---|---|
| 0 | 0 | 0 |
| 1 | 0 | 1 |
| 63 | 0 | 63 |
| 64 | 1 | 0 |
| 127 | 1 | 63 |
| 128 | 2 | 0 |
| i | i/64 | i mod 64 |

Each classifier is composed of two BitStrings, the condition and the action. The BitString class provides functions for creating BitStrings, for testing if two BitStrings are equal, for cloning a BitString, for accessing bits from a BitString and for modifying the bits of a BitString.

ConditionBitString

The ConditionBitString class is derived from the BitString class. This class has an additional array of longs which functions as a Don't Care mask. If any bit in the Don't Care mask is set then the corresponding bit in the original array is a Don't Care bit. The ConditionBitString class provides functions for determining if two ConditionBitStrings match. Using a series of exclusive-or operations tests matching.

Classifier

A Classifier is an abstract class. In order the use the XCS package, one must derive a Classifier class from this parent. Implementations for the functions localInit and clone must be provided. When the ClassifierSystem is created, it is given the name of the derived Classifier class so that any Classifiers that are created in the ClassifierSystem will be of the derived type.

A Classifier has three parts: a condition, an action and some statistics. Both the condition and action are BitStrings. A Classifier has two constructors: the public constructor is used to create a Classifier with an empty condition and empty action. The function fillClassifier must be used to actually set the condition and action. The private constructor is only used to clone an existing Classifier. Functions are provided to mutate, crossover, test for equality, test for matching, modify the statistics, and read the statistics.

ClassifierStatistics

The ClassifierStatistics class encapsulates all of the classifier statistics. Functions are provided for accessing and modifying the statistics. The algorithms for updating the statistics are described in detail in the table found in the XCS Classifier Statistics section.

ClassifierSystem

The only interface with the outside world is through the ClassifierSystem class. One can create a ClassifierSystem, give an input to the system, receive an output from the system, give a reward to the system and query the system for the current classifier population. When a ClassifierSystem is created, it is given the name of the Classifier class to use when creating new classifiers and is given the system parameters to use in the execution of the XCS algorithm.

ClassifierPopulation

The ClassifierPopulation class contains the collection of classifiers that the XCS algorithm uses. Functions exist for inserting and deleting classifiers and for searching the population for classifiers that match an input.

ConditionMatchSet

The ConditionMatchSet class is used to create Condition Match Sets. A Condition Match Set is a collection of classifiers from the population whose condition matches a given input string. For traditional XCS classifiers, a classifier is said to “match” an input string if: 1. Condition length and input length are equal 2. For every bit in the condition, the bit is either a # or it is the same as the corresponding bit in the input. Matching for Digital Deal classifiers is much more complicated. A Condition Match Set is said to “cover” an input if the number of classifiers in the match set is at least equal to some minimum number. Functions exist for creating the prediction array from the match set, for enumerating the match set and to test if the match set covers an input.

PredictionArray

The prediction array stores the predicted payoff for each possible action in the system. The predicted payoff is a fitness-weighted average of the predictions of all classifiers in the condition match set that advocate the action. If no classifiers in the match set advocate the action then the prediction is NULL. Ideally, the prediction array is an array with a spot for each possible action. For our system, the number of possible actions is too big so we will only add actions for which a classifier advocating that action exists. Functions exist for creating a PredictionArray from a ConditionMatchSet, for returning the best action based on predicted payoff and for returning a random action. The fitness-weighted average is computed as follows:
1. For a given action, compute the weighted prediction. The weighted prediction is the sum of the prediction*fitness for each classifier advocating that action.
2. For a given action, compute the total fitness. The total fitness is the sum of the fitness for each classifier advocating that action.
3. The fitness-weighted average for an action is the weighted prediction/total fitness.
   ActionSet

During the course of the XCS algorithm, an action is selected from all the possible actions specified in the Condition Match Sets. The ActionSet class contains the set of classifiers from the Condition Match Set that have actions that match the selected action. The GA is run only on the ActionSet. For each iteration of the XCS algorithm, a new ActionSet is formed. If the size of the Action Set is greater than one then action set subsumption takes place. In action set subsumption, the Action Set is searched for the most general classifier that is both accurate and sufficiently experienced. If such a classifier is found then all the other classifiers in the set are tested against this general one to see if it subsumes them. Any classifiers that are subsumed are removed from the population. Setting the subsumption flag in the system parameters to false can disable action set subsumption. Since the GA is run on the Action Set, it is not obvious how this algorithm can be used with historical data. Functions are included for updating all of the classifier statistics, doing action set subsumption, and running the genetic algorithm.

XCSexception

This class is the exception class for the XCS algorithm. This exception is thrown when functions to implement the XCS algorithm are used incorrectly. For example, an XCSexception is thrown if one attempts to update the prediction before updating the experience.

Digital Deal Classifier

The Digital DealClassifier class is derived from the abstract class Classifier. As stated earlier, Digital Deal classifiers have special requirements for generating matching classifiers, generating random actions and checking for matching classifiers. This class provides all of the special functionality. When the ClassifierSystem is created then pass the name of this class to it.

### Initial Digital Deal Classifier Population

Since XCS is capable of generating classifiers, it can start with an empty population. However, the learning process is much quicker if XCS is given some knowledge with which to start. Since Digital Deal works well, it seems logical to seed the classifier population with the Digital Deal rules. The Initial Rule Generator application extracts the Digital Deal rules from the historical order and offer data. The application can be run from the Start Menu by choosing DPUM>BioNET Initial Rule Generator.

The BioNET.properties file is a flat property file that is used to configure the behavior of the application. The properties file can be found in c:\Program Files\DRS\DPUM\BioNET and can be edited with any editor. An explanation of the fields in the property file is given later.

Algorithm Design

The following is a step-by-step explanation of the extraction and translation process.
1. Create the following tables in the database: The ClassifierCondition table has fields: Condition, Don't Care, Action Type, Experience, Action Set Size, Prediction, Fitness, Numerosity, Accuracy, Error, GA Iteration, The ClassifierAction table has fields for the action. The ConditionAction table is the link table to link the condition and action.
2. Perform the following query to extract the orders from the order table:

SELECT OrderTable.OrderID, OfferItem.Replace, OrderTable.DestinationID, OrderTable.PeriodID, OrderTable.RegisterID, OrderTable.CashierID, OrderTable.DTStamp, OrderTable.Total, OrderItem.MenuItemID, OrderItem.Price, OrderItem. Quantity, OfferItem.MenuItemID, OfferItem.Quantity, OfferItem.OfferPrice, OrderItem.DPUMItem, OrderItem.ParentItemID, OfferItem.ReplaceMenuItemID FROM (OrderItem INNER JOIN OrderTable ON OrderItem.OrderID=OrderTable.OrderID) INNER JOIN OfferItem ON OrderTable.OrderID=OfferItem.OrderID WHERE (((OrderTable.OrderStatusID)=4) AND ((OfferItem.AcceptStatusID)=) AND ((Orderltem.Deleted)=0)) AND (OrderTable.DTStamp IS NOT NULL) ORDER BY OrderTable.DTStamp DESC
3. Using the first 10000 rows of the query result set, create QSRorder objects from all rows with the same Order ID.
4. Translate each QSRorder into 1 or more classifiers.
5. Add each classifier to a classifier population
6. For each classifier in the population, add Don't Cares to the condition.
7. For each classifier in the population, set the statistics to the default values.
8. Write the classifier population to the database.
   Modifying the Run-Time Behavior of the Initial Rule Generator

The InitialRules application has a property file that is used to modify its run-time behavior. The following TABLE 5 is an explanation of the properties in the file.

TABLE 5

| Property Name | Description | Example |
|---|---|---|
| jdbc.drivers | Contains a list of class | sun.jdbc.odbc.JdbcOdbcDriver |
| | names for the database | |
| | drivers. We are using the jdbc- | |
| | odbc bridge so what is shown | |
| | in the example is always valid. | |
| jdbc.url | URL of the database to | jdbc:odbc:McDs |
| | connect to. Since we are | |
| | using the JDBC-ODBC bridge, | |
| | the URL will start with | |
| | “jdbc:odbc” and the last | |
| | part must be set with the ODBC | |
| | Data Sources tool in the Control | |
| | Panel. | |
| jdbc.username | Login ID of the user to | sa |
| | log into the database | |
| jdbc.password | Password needed to log | |
| | the user into the database | |
| closedOrderStatusId | Value in the | 4 |
| | OrderStatusID column of | |
| | the OrderTable table that | |
| | indicates a closed order. | |
| acceptStatusId | Value in the | 1 |
| | AcceptStatusID column | |
| | of the OfferItem table | |
| | that indicates an accepted | |
| | offer. | |
| numerosityMin | The minimum number of | 4 |
| | duplicates needed for a | |
| | rule generated from an | |
| | order to be written to the | |
| | database. For example, if | |
| | set to a 1 then every order | |
| | will be translated to a rule | |
| | and written to the | |
| | database. If set to a 2 | |
| | then the order must | |
| | appear at least twice. | |
| printClassifiers | Set to a 1 if you want the | 0 |
| | rules written to standard | |
| | output as they are written | |
| | to the database. Set to 0 | |
| | otherwise. | |
| printOrders | Set to a 1 if you want the orders | 0 |
| | written to standard output as | |
| | they are found. Set to a 0 | |
| | otherwise. | |

Properties are entered into the property file by typing propertyName=value. There should be no spaces between the name, =, and value. Notice that when a path and file name is given, the path can use forward slashes (/) or backward slashes (\) but when backward slashes are used they must be doubled. Java is case-sensitive so be careful.

### Translating Digital Deal Classifiers to English

Using the Translation application, Digital Deal classifiers can be translated to English. Each classifier is translated to a string with each field delimited with the delimiter of your choice. The translation can then be exported to Excel or any other spreadsheet.

The Translator translates the Digital Deal classifiers into 3 different forms: a paragraph form, a parsed one-line form and into English. By far, the English version is the most useful but the other two forms are good for debugging.

The paragraph form parses each field (day of week, casher id, etc) of the classifier onto a separate line. The following is an example of one classifier translated into paragraph form:

---CONDITION---
---ENVIRONMENT---
Day of Week: 10#0#00
Period ID: 000#####000#00000##00####000000#0
Month: 00000000100#
Time of Day —Hour: ##001
Cashier ID: 00#000000##0##000000000##0#####0
Register ID: 000#00000000000#00000##0#00001##
Destination ID: 0000###0#00#0#0###0##000000#0#0##
---ITEM 1---
Type: 0000#00###00
Size: 000000000010
Time of Day Available: #00110
Discounted: 0
Prepackaged: 0
Temperature: ####000##001
Side: 0000##00##00000#0##0##0#0#0000000001##00000#00###00###00#00#0000
---ITEM 2---
Type: 0000##0000##
Size: 0###000##000
Time of Day Available: 00#000
Discounted: 0
Prepackaged: #
Temperature: 0#000##00000
Empty-Item: ##00#0#000#0000#000###0#0#00#0000#0000##0000000#0##000#000#0#000
---ITEM 3---
Type: 000000#00##0
Size: 000000###0#0
Time of Day Available: 000000
Discounted: #
Prepackaged: 0
Temperature: ##000#0000##
Empty-Item: 00000#0000000000000000#000000000###0000000###0##0#000#00#000####
---ITEM 4---
Type: 00#00##0###0
Size: 0000000000##
Time of Day Available: #0##00
Discounted: 0
Prepackaged: 0
Temperature: 000#0####00#
Empty-Item: 0000000000#0#0#000##000000#000##000##00##0000#000000#00##0###00#
---ITEM 5---
Type: 0##00##0##0#
Size: 00000#000#0#
Time of Day Available: 00#00#
Discounted: 0
Prepackaged: 0
Temperature: 0#0000000###
Empty-Item: 000#0#00#00000000##0#0000#00##00#0###000#000000##00#00#0#0#00#00
---ITEM 6---
Type: 0#0#000000##
Size: #0##0000#0##
Time of Day Available: 0#0000
Discounted: 0
Prepackaged: 0
Temperature: 000#00000000
Empty-Item: #0000#0#000000000#0#00#####0#000#00#0000000#000#00#00#0##0000#00
---ACTION---
Action-Type: REPLACE
---REPLACED ITEM---
---ITEM 1---
Menu Item Id: 11
Type: 000000000100
Size: 000000000010
Time of Day Available: 000110
Discounted: 0
Prepackaged: 0
Temperature: 000000000001
Side: 0000000000000000000000000000000000010000000000000000100000000000
---REPLACED WITH---
---ITEM 1---
Menu Item Id: 110
Type: 000000000100
Size: 000000000100
Time of Day Available: 000110
Discounted: 0
Prepackaged: 0
Temperature: 000000000001
Side: 0000000000000000000000000000000000010000000000000000100000000000
N: 5 P: 10.0000 E: 0.0000 A: 0.0100 F: 0.0100 EXP: 0.0000 AS: 1.0000 GA: 0.0000
Condition ID: 1
Action IDs: 1, 2

The one-line parsed form is slightly more useful than the paragraph form. It returns each classifier on one line with a delimiter of your choice between each field. The output can then be exported to Excel to see the bits representing each field. The menu item id, condition id and action id are shown in decimal and not in binary. The following is an example using a ‘!’ as the delimiter:

Condition ID!Day of Week!Period ID!Month!Time of Day —Hour!Cashier ID!Register ID!Destination
ID!Type!Size!Time of Day Available!Discounted!Prepackaged!Temperature!Type-Properties!Type!Size!Time
of Day Available!Discounted!Prepackaged!Temperature!Type-Properties!Type!Size!Time of Day
Available!Discounted!Prepackaged!Temperature!Type-Properties!Type!Size!Time of Day
Available!Discounted!Prepackaged!Temperature!Type-Properties!Type!Size!Time of Day
Available!Discounted!Prepackaged!Temperature!Type-Properties!Type!Size!Time of Day
Available!Discounted!Prepackaged!Temperature!Type-Properties!Action-Type!Action ID!Menu Item
ID!Type!Size!Time of Day Available!Discounted!Prepackaged!Temperature!Type-Properties!Action ID!Menu
Item ID!Type!Size!Time of Day Available!Discounted!Prepackaged!Temperature!Type-Properties
1!10#0#00!000#####000#00000##00####000000#0!00000000100#!##001!00#000000##0##000000000##0##
###0!000#00000000000#00000##0#00001##!0000###0#00#0#0###0##000000#0#0##!0000#00###00!000000
000010!#00110!0!0!####000##001!0000##00##00000#0##0##0#0#0000000001##00000#00###00###00#00#
0000!0000##0000##!0###000##000!00#000!0!#!0#000##00000!##00#0#000#0000#000###0#0#00#0000#000
0##0000000#0##000#000#0#000!000000#00##0!000000###0#0!000000!#!0!##000#0000##!00000#00000000
00000000#000000000###0000000###0##0#000#00#000####!00#00##0###0!0000000000##!#0##00!0!0!000#
0####0#!0000000000#0#0#000##000000#000##000##00##0000#000000#00##0###00#!0##00##0##0#!0000
0#000#0#!00#00#!0!0!0#0000000###!000#0#00#00000000##0#0000#00##00#0###000#000000##00#00#0#0
#00#00!0#0#000000##!#0##0000#0##!0#0000!0!0!000#00000000!#0000#0#000000000#0#00#####0#000#00
#0000000#000#00#00#0##0000#00!REPLACE!1!11!000000000100!000000000010!000110!0!0!00000000000
1!0000000000000000000000000000000000010000000000000000100000000000!2!110!000000000100!00000
0000100!000110!0!0!000000000001!00000000000000000000000000000000000100000000000000001000000
00000

The third form translates each field of the classifier to English and separates the fields by a delimiter of your choice. A good choice is ‘1’ since the period id field often has ‘&’ in it and the menu item field often has ‘$’ and ‘,’ in it. A detailed explanation of this form is given in section 5.

How Do You Use It?

The application can be run from the Start Menu by choosing DPUM>BioNET Translator. The BioNET.properties file is a flat property file that is used to configure the behavior of the application. The properties file can be found in c:\Program Files\DRS\DPUM\BioNET. This file can be edited with an editor and contains the following properties in TABLE 6:

TABLE 6

| Property Name | Description | Example |
|---|---|---|
| jdbc.drivers | Contains a list of class | sun.jdbc.odbc.JdbcOdbcDriver |
| | names for the database | |
| | drivers. We are using the | |
| | jdbc-odbc bridge so what | |
| | is shown in the example | |
| | is always valid. | |
| jdbc.url | URL of the database to | jdbc:odbc:McDs |
| | connect to. Since we are | |
| | using the JDBC-ODBC | |
| | bridge, the URL will start | |
| | with “jdbc:odbc” and the | |
| | last part must be set with | |
| | the ODBC Data Sources | |
| | tool in the Control Panel. | |
| jdbc.username | Login ID of the user to | Sa |
| | log into the database | |
| jdbc.password | Password needed to log | |
| | the user into the database | |
| separator | The delimiter for the | |
| | fields of the English | |
| | translations. | |
| translatorOutputFile | Name of the file that the | c:/Program |
| | translated classifiers | Files/DRS/DPUM/BioNET/trans.txt |
| | should be written to. If | |
| | this file does not exist, it | |
| | will be created. If it does | |
| | exist, it will be | |
| | overwritten. If the value | |
| | is left blank then the | |
| | translations will be sent | |
| | to standard output. | |

Properties are entered into the property file by typing propertyName=value. There should be no spaces between the name, =, and value. Notice that when a path and file name is given, the path can use forward slashes (/) or backward slashes (\) but when backward slashes are used they must be doubled. Java is case-sensitive so be careful.

What's in the English Translation?

Referring to TABLE 7, the English translation shows what values of each field the condition will match to and what the action will be if that classifier is selected.

TABLE 7

| Field Name | Values | Example |
|---|---|---|
| Condition ID | Gives the ConditionID from | Condition ID = 12 |
| | the ClassifierCondition | |
| | table in the DPUM database | |
| Day of Week | Lists the days of the week | Monday or Saturday |
| | that this classifier will | |
| | match to | |
| Period ID | Gives the periods that this | Lunch & Dinner or Late |
| | classifier will match to | Breakfast |
| Month | Lists the months of the year | Apr or July |
| | that this classifier will | |
| | match to | |
| Time of Day - Hour | Lists the hours of the day | 3 or 5 |
| | (24 hour clock) that this | |
| | classifier will match to | |
| Cashier ID) | Lists the names and ids of | Gore, Al (45) or Bush, |
| | the cashiers that this | George(9) |
| | classifier will match to | |
| Register ID | Lists the registers and ids of | Far-Left (8) or Register 9 |
| | the registers that this | (3) |
| | classifier will match to | |
| Destination ID | Lists the destinations that | Front Counter or Drive-up |
| | this classifier will match to | |
| Ordered Items | Lists the ordered items and | [Cajun(17)] or [ ] or [ ] or [ ] |
| | ids that this classifier will | or [ ] or [ ] |
| | match to. Each classifier | |
| | contains up to 6 menu items | |
| | so the matches for each | |
| | menu item are placed in | |
| | brackets. | |
| Action-Type | Add or Replace | ADD |
| Action ID) | Gives the ActionID from | Action ID = 23 |
| | the ClassifierAction table in | |
| | the DPUM database | |
| Replaced or Offered Items | If the action is a REPLACE | |
| | then this lists the item from | |
| | the order that will be | |
| | replaced. If the action is an | |
| | ADD then this is the item to | |
| | offer. | |
| Action ID | If the action is a REPLACE | Action ID = 26 |
| | then this is the ActionID | |
| | from the ClassifierAction | |
| | table in the DPUM database | |
| | If the action is an ADD then | |
| | this will be blank. | |
| Offered Item | If the action is a REPLACE | |
| | then this is the menu item to | |
| | offer. | |
| | If the action is an ADD then | |
| | this will be blank. | |

### Reports

In addition to the Translator, there is a Reporting application that gives a summary of the Classifiers in the DPUM database. The reporting application provides the following information:
1. Number of Classifiers in the database
2. Number of Classifiers with ADD actions
3. Number of Classifiers with REPLACE actions
4. Top 10 most popular classifiers
5. Top 10 most likely to be selected classifiers (a.k.a. classifiers with the highest predictions)
6. Score of the database

The application can be run from the Start Menu by choosing DPUM>BioNET Reports. The BioNET.properties file is a flat property file that is used to configure the behavior of the application. The properties file can be found in c: \Program Files\DRS\DPUM\BioNET. This file can be edited with an editor and contains the following properties described in TABLE 8:

| Property Name | Description | Example |
|---|---|---|
| jdbc.drivers | Contains a list of class | sun.jdbc.odbc. |
| | names for the database | JdbcOdbcDriver |
| | drivers. We are using the | |
| | jdbc-odbc bridge so | |
| | what is shown in the | |
| | example is always valid. | |
| jdbc.url | URL of the database to | jdbc:odbc:McDs |
| | connect to. Since we are | |
| | using the JDBC-ODBC | |
| | bridge, the URL will | |
| | start with “jdbc:odbc” | |
| | and the last part must be | |
| | set with the ODBC Data | |
| | Sources tool in the | |
| | Control Panel. | |
| jdbc.username | Login ID of the user to | Sa |
| | log into the database | |
| jdbc.password | Password needed to log | |
| | the user into the | |
| | database | |
| separator | The delimiter for the | ! |
| | fields of the English | |
| | translations. | |
| reportsOutputFile | Name of the file that the | c:/Program |
| | report will be written to. | Files/DRS/DPUM/BioNET/ |
| | If this file does not exist, | reports.txt |
| | it will be created. If it | |
| | does exist, it will he | |
| | overwritten. If the value | |
| | is left blank then the | |
| | translations will be sent | |
| | to standard output. | |

### Installation of BioNET-XCS

The BioNET-XCS is installed by running the InstallShield executable that is provided. It installs the actual BioNET and the four tools (Translator, Initial Rules, Reports and MenuEditor) in the directory c: \Program Files\Drs\Dpum\BioNET. To use the BioNET via DPUM, you have to edit the BioNET.properties file. Properties are described in TABLE 9.

TABLE 9

| Property Name | Description | Example |
|---|---|---|
| jdbc.drivers | Contains a list of class | sun.jdbc.odbc.JdbcOdbcDriver |
| | names for the database | |
| | drivers. We are using the | |
| | jdbc-odbc bridge so what | |
| | is shown in the example is | |
| | always valid. | |
| jdbc.url | URL of the database to | jdbc:odbc:McDs |
| | connect to. Since we are | |
| | using the JDBC-ODBC | |
| | bridge, the URL will start | |
| | with “jdbc:odbc” and the | |
| | last part must be set with | |
| | the ODBC Data Sources | |
| | tool in the Control Panel. | |
| jdbc.username | Login ID of the user to log | Sa |
| | into the database | |
| jdbc.password | Password needed to log | |
| | the user into the database | |
| breakfast | The PeriodID from the | 1, 3, 10 |
| | Period table in the DPUM | |
| | database that denotes | |
| | breakfast. If there is more | |
| | than one id for breakfast | |
| | then list them all separated | |
| | by commas. | |
| lunch | The PeriodID from the | 2 |
| | Period table in the DPUM | |
| | database that denotes lunch. | |
| | If there is more than one id | |
| | for lunch then list them all | |
| | separated by commas. | |
| dinner | The PeriodID from the | 2 |
| | Period table in the DPUM | |
| | database that denotes | |
| | dinner. If there is more | |
| | than one id for dinner then | |
| | list them all separated by | |
| | commas. | |
| anyPeriod | The PeriodID from the | −2 |
| | Period table in the DPUM | |
| | database that denotes any | |
| | period. If there is more than | |
| | one id for any period then | |
| | list them all separated by | |
| | commas. | |
| logEnable | Set to a 1 if you want the | 1 |
| | output of the XCS algorithm | |
| | logged to a file. This should | |
| | only be a 1 for debugging | |
| | since logging makes things | |
| | very slow. | |
| logFileName | Name of the file to output | c:/Program |
| | XCS logging to. If the file | Files/DRS/DPUM/BioNET/xcsLog.txt |
| | exists then new log | |
| | messages are appended to it. | |
| | If it does not exist then it is | |
| | created. | |

### REFERENCES

One of ordinary skill in the art may refer to the following references for a description of XCS.
Kovacs, T. (1996), “Evolving Optimal Populations with XCS Classifier Systems”, MSc. Dissertation, Univ. of Birmingham, UK.
Wilson, S. W. (1995), “Classifier Fitness Based on Accuracy”, Evolutionary Computation, 3 (2), MIT Press.
Wilson, S. W., Butz, M. V. (2000), “An Algorithmic Description of XCS”, IlliGAL Report No. 2000017, University of Illinois at Urbana-Champaign.

### Appendix A-1—XCS System Parameters

TABLE 10

| | |
|---|---|
| Classifier | A bit string encoding of an “if-then” rule where each bit can be either a 0, 1 or |
| | #. The ‘#’ indicates a “don't care” and can be matched to either a 1 or 0. The |
| | “if” part of the classifier is called the condition and the “then” part is called the |
| | action. The action cannot contain any “#” characters. The format for a |
| | classifier is usually something like: 00##100#1110### [symbol] 101 |
| Classifier System | A machine learning system that uses “if-then”rules to react to its environment. |
| | A genetic algorithm is used to discover new rules for the environment. |
| XCS | A classifier system where the fitness of a classifier is based on the accuracy of |
| | the payoff prediction as opposed to being based on the prediction itself. |
| GA | Genetic Algorithm |
| Condition Match Set | The set of classifiers that match the given input from the environment (e.g.. an |
| | order of a Big Mac). For example, suppose a Big Mac is encoded as 10010 |
| | and the condition parts of the classifiers in the population are: |
| | a. #0010 |
| | b. ###00 |
| | c. 1##10 |
| | d. 10010 |
| | e. 1##00 |
| | f. 10#0# |
| | Then the match set consists of: a, c, d. |
| Cover an Input | The process of creating a classifier that matches an input. If the Condition |
| | Match Set is empty than generate a classifier by taking the input and randomly |
| | replacing some of the characters with #'s and then randomly generating an |
| | action that is not present in the Condition Match Set. |
| Exploration | Randomly choose an action from the Condition Match Set. |
| Exploitation | Choose the best (as defined by the prediction array) action from the Condition |
| | Match Set. |
| Action Set | The set of classifiers from the Condition Match Set whose action matches the |
| | action that was chosen with either exploration or exploitation. |
| Microclassifier | Same as a classifier |
| Macroclassifier | If a classifier is created that has the same condition and action as another |
| | classifier then the existing classifier is said to be a Macroclassifier. Instead of |
| | adding a second identical classifier to the population, the Numerosity of the |
| | original classifier is incremented by 1. A classifier can only be deleted if its |
| | Numerosity is 0. If a classifier is marked for deletion and has a Numerosity of |
| | greater than 0 then decrement the Numerosity. The total number of classifiers |
| | in a population is the stun of the numerosities of all the classifiers in the |
| | population. |
| Subsumption | Let A and B be two classifiers with the same action. If the set of inputs that A |
| | will match is a superset of the set of inputs that B will match then A subsumes |
| | B. |
| GA Subsumption | If an offspring classifier is logically subsumed by the |
| | condition of an accurate and sufficiently experienced parent then the offspring |
| | is not added to the population but instead the numerosity of the parent is |
| | incremented. GA Subsumption can be disabled. |
| Action Set | This takes place in the action set. The action set is searched |
| Subsumption | for the most general classifier that is both accurate and sufficiently experienced |
| | then all other classifiers in the set are tested against this general one to see if it |
| | subsumes them. Any classifiers that are subsumed are removed from the |
| | population. Action Set Subsumption can be disabled. |
| Roulette Wheel | A method of selection where each classifier is conceptually given a slice of a |
| Selection | circular roulette wheel. The slice is equal in area to the classifier's fitness. A |
| | classifier is selected by spinning the wheel. The algorithm is as follows: |
| | Let fitnessSum = sum of fitness values for all classifiers in the action set |
| | Let randomPoint = random number in [0, 1] * fitnessSum |
| | Set fitnessSum = 0 |
| | For each classifier in the action set |
| | fitnessSum = fitnessSum + fitness of classifier |
| | if (fitnessSum > randomPoint) |
| | Return (classifier) |
| Prediction Array | An array that stores the predicted payoff for each possible action in the system. |
| | The predicted payoff is a fitness-weighted average of the predictions of all |
| | classifiers in the Condition Match Set that advocate that action. If no |
| | classifiers in the Condition Match Set advocate that action then the prediction |
| | is NIL. |
| MAM Technique | Used to speed up the estimates of classifier parameters based on information |
| | obtained on successive cycles. Using this technique, a parameter is updated |
| | using one method early on and a second method later. The reasoning is that |
| | the first method can be used to quickly get a rough approximation of the true |
| | value, while the second method can make more conservative adjustments in |
| | order to refine the value. |

### Appendix A-2—Food Items Data Model

The general idea of the data model is to represent each item of an order by defining the item's properties. For example: Instead of saying a Big Mac is Menu Item #4, we will say that a Big Mac is something with Beef, Bread, Special Sauce, Lettuce, Tomato and a Pickle.

Design Goals

1. Design should be abstract enough to handle any food item from Extra Sour Cream at Taco Bell to Red Lobster's Shrimp Feast.
2. Design should introduce as little bias as possible.
3. Should be able to compare food items. This is the reason that numerical identifiers do not work. How does one compare a 5 to a 10? Numerical identifiers have no meaning. With an abstract model, we can talk about comparing the various properties of two items.
4. Should be able to compare food items from different brands. For example, compare Whoppers to Big Macs.
   Model Description

An order is comprised of two objects: an Environment object and a Meal object.

Environment Object

The Environment object consists of the following:

Time-of-Day

Destination (Take-out, Eat-in, Deliver, Drive-Thru)

Day-Of-Week

Payment Method

Customer ID

Store ID

Weather

Party Size

Meal Object

A Meal object consists of 6 Menu Item objects. Some of the Menu Item objects in a Meal can be NULL. There are 6 different kinds of Menu Item objects: Main, Side, Beverage, Dessert, Miscellaneous, Topping/Condiment. A Meal object does not have to have one of each of the Menu Item types in it; it is perfectly valid for a Meal object to have, say, 2 Side Menu Items.

Examples of Meal objects:

Big Mac, Large Fries, Small Coke, NULL, NULL, NULL

Apple Pie, Coffee, NULL, NULL, NULL, NULL

Chicken Leg, Coleslaw, Baked Beans, Biscuit, Ice Cream, Iced Tea

Coke, NULL, NULL, NULL, NULL, NULL

Menu Item Object

A Menu Item comprises two things: an ID and list of binary-encoded properties. The ID is used only to query the Digital Deal database to get pricing and cost information and to get the name of the object to construct the offer string. Each Menu Item has a set of common properties and a set of properties that are unique to the Menu Item type. The properties are OR'ed together to form a binary descriptor. This descriptor must be stored in the Digital Deal database.

TABLE 11
Common Properties of a Menu Item

| Property Name | Value | Encoding |
|---|---|---|
| Type | Beverage | 000001 |
| | Main | 000010 |
| | Side | 000100 |
| | Dessert | 001000 |
| | Condiment | 010000 |
| | Miscellaneous | 100000 |
| Size | Child | 000001 |
| If no size (like a Big Mac) is | Small | 000010 |
| specified then the size is Medium. | Medium | 000100 |
| | Large | 001000 |
| | Extra-Large | 010000 |
| | All-U-Can-Eat | 100000 |
| Temperature | Hot | 001 |
| | Cold | 010 |
| | Room | 100 |
| Pre-packaged | False | 0 |
| | True | 1 |
| Discounted | False | 0 |
| | True | 1 |
| Time-Of-Day-Available | Any Time | 111 |
| | Breakfast | 001 |
| | Lunch | 010 |
| | Dinner | 100 |

TABLE 12
Beverage Menu Item Properties

| Property Name | Encoding |
|---|---|
| Water | 0000000000000000000000000000000001 |
| Milk | 0000000000000000000000000000000010 |
| Soda | 0000000000000000000000000000000100 |
| Fruit Juice | 0000000000000000000000000000001000 |
| Coffee | 0000000000000000000000000000010000 |
| Tea | 0000000000000000000000000000100000 |
| Beer | 0000000000000000000000000001000000 |
| Wine | 0000000000000000000000000010000000 |
| Liquor | 0000000000000000000000000100000000 |
| Chocolate | 0000000000000000000000001000000000 |
| Ice (like a Smoothie) | 0000000000000000000000010000000000 |
| Decaffeinated | 0000000000000000000000100000000000 |
| Diet | 0000000000000000000001000000000000 |
| Ice Cream | 0000000000000000000010000000000000 |
| Vegetable | 0000000000000000000100000000000000 |
| Protein-Shake | 0000000000000000001000000000000000 |
| Flavorings (like Vanilla, | 0000000000000000010000000000000000 |
| Orange, Fox's uBet Chocolate | |
| Syrup) | |
| Cappuccino | 0000000000000000100000000000000000 |
| Espresso | 0000000000000001000000000000000000 |

TABLE 13
Main & Side Menu Item Properties

| Name | Encoding |
|---|---|
| Egg | 0000000000000000000000000000000001 |
| Chicken | 0000000000000000000000000000000010 |
| Beef/Veal | 0000000000000000000000000000000100 |
| Lamb | 0000000000000000000000000000001000 |
| Turkey | 0000000000000000000000000000010000 |
| Pork | 0000000000000000000000000000100000 |
| Fish | 0000000000000000000000000001000000 |
| Seafood | 0000000000000000000000000010000000 |
| Other Meat | 0000000000000000000000000100000000 |
| Cheese | 0000000000000000000000001000000000 |
| Spices (Cajun, Blackened, | 0000000000000000000000010000000000 |
| Teriyaki, etc) | |
| Potato | 0000000000000000000000100000000000 |
| Onion | 0000000000000000000001000000000000 |
| Corn | 0000000000000000000010000000000000 |
| Mushroom | 0000000000000000000100000000000000 |
| Coleslaw | 0000000000000000001000000000000000 |
| Lettuce | 0000000000000000010000000000000000 |
| Peppers | 0000000000000000100000000000000000 |
| Other Vegetables | 0000000000000001000000000000000000 |
| Fruit | 0000000000000010000000000000000000 |
| Mayo | 0000000000000100000000000000000000 |
| Sauce/Dressing | 0000000000001000000000000000000000 |
| Soy (Tofu, Veggie-Burger, etc | 0000000000010000000000000000000000 |
| Nuts | 0000000000100000000000000000000000 |
| Beans | 0000000001000000000000000000000000 |
| Pasta | 0000000010000000000000000000000000 |
| Rice | 0000000100000000000000000000000000 |
| Is_Salad | 0000001000000000000000000000000000 |
| Is_DeepFried | 0000010000000000000000000000000000 |
| Is_Soup | 0000100000000000000000000000000000 |
| Is_Sandwich (Taco, Burrito, | 0001000000000000000000000000000000 |
| Pita-Wrap etc) | |
| Is_Pizza | 0010000000000000000000000000000000 |
| Bread | 0100000000000000000000000000000000 |
| Batter (Waffles, Pancakes) | 1000000000000000000000000000000000 |

TABLE 14
Dessert Menu Item Properties

| Property Name | Encoding |
|---|---|
| Fruit | 0000000000000000000000000000000001 |
| Pastry | 0000000000000000000000000000000010 |
| Dairy (Cheese, Whipped | 0000000000000000000000000000000100 |
| Cream) | |
| Chocolate | 0000000000000000000000000000001000 |
| Cookie | 0000000000000000000000000000010000 |
| Candy | 0000000000000000000000000000100000 |
| Cake | 0000000000000000000000000001000000 |
| Chips | 0000000000000000000000000010000000 |
| Nuts | 0000000000000000000000000100000000 |
| Coconut | 0000000000000000000000001000000000 |
| Caramel | 0000000000000000000000010000000000 |
| Is_CreamFilled | 0000000000000000000000100000000000 |
| Is_FruitFilled | 0000000000000000000001000000000000 |
| Frozen Treat | 0000000000000000000010000000000000 |
| Batter | 0000000000000000000100000000000000 |
| Ice Cream | 0000000000000000001000000000000000 |

TABLE 15
Miscellaneous Menu Item Properties

| Property Name | Encoding |
|---|---|
| Toy | 0000000000000000000000000000000001 |
| Video | 0000000000000000000000000000000010 |
| Newspaper | 0000000000000000000000000000000100 |
| Salad Bar | 0000000000000000000000000000001000 |

TABLE 16
Topping/Condiment Menu Item Properties

| Property Name | Encoding |
|---|---|
| Salsa | 0000000000000000000000000000000001 |
| Cream Cheese | 0000000000000000000000000000000010 |
| Extra Dressing | 0000000000000000000000000000000100 |
| Sour Cream | 0000000000000000000000000000001000 |
| Butter | 0000000000000000000000000000010000 |
| Guacamole | 0000000000000000000000000000100000 |
| Fruit | 0000000000000000000000000001000000 |
| Dessert Topping (Sprinkles, | 0000000000000000000000000010000000 |
| Cookies, etc) | |

Examples of Menu Item Encodings
Regular McDonald's Apple Pie=>Type=Dessert, Size=Medium, Temperature=Hot, Pre-packaged=True, Discounted=False, Time-Of-Day-Available=Anytime, Properties=Fruit, Pastry, Is_FruitFilled
Encoding=00100 000100 001 1 0 111 0000000000000000000001000000000011
Senior Large Coke=>Type=Beverage, Size=Large, Temperature=Cold, Pre-packaged=False, Discounted=True, Time-Of-Day-Available=Anytime, Properties=Soda
Encoding=00001 001000 010 0 1 111 0000000000000000000000000000000100
Creating Binary Descriptors

We will need an application with a graphical interface to enter properties for menu items and categories.

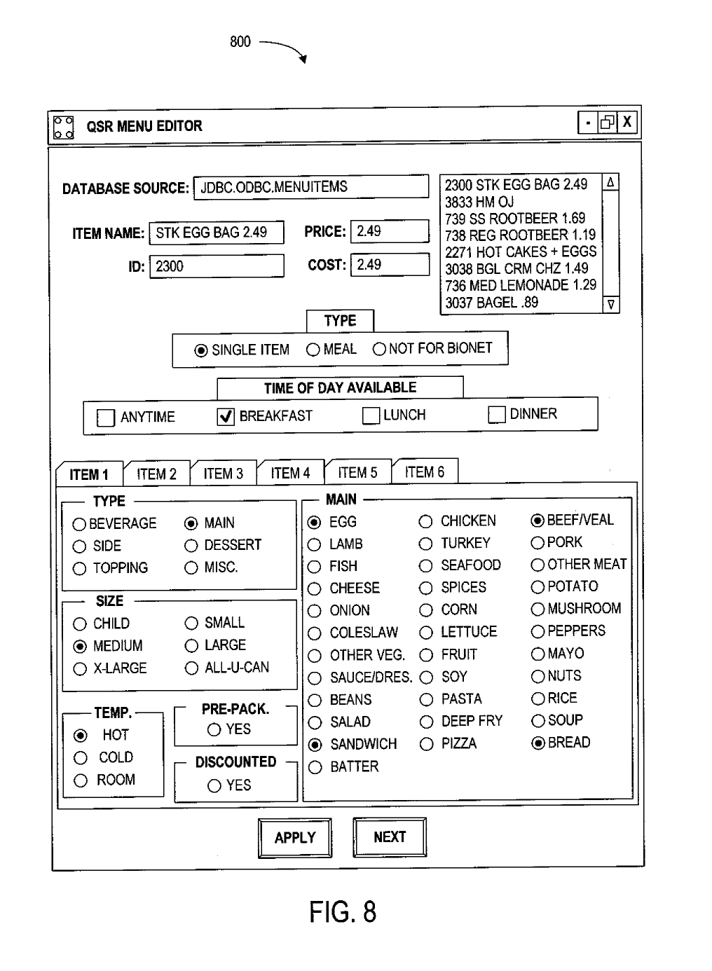

The application may be something like the exemplary window 800 illustrated in FIG. 8:

Design considerations of the Menu Editor application:
1. Should be able to query the Digital Deal database for a list of the Menu Items and their properties.
2. Should be able to query the Digital Deal database for a list of the Categories and their properties.
3. Should be able to write the properties to the Digital Deal database.
4. Should be able to set the properties for a selected Menu Item or Category.
5. Should prevent the user from assigning dessert properties to a side item, etc.
6. Should have item templates like HAMBURGER, CHEESEBURGER, etc.

### Appendix B

The Nature of the Problem

Motivation

Optimizing value-added POS transactions for the restaurant industry is a formidably complex task, without even considering the notion of generic business practices. However, suitable AI and machine-learning methods can be implemented which, when presented with sufficient high-quality historical data and clock cycles, will likely be able to outperform hard-coded expert systems by a significant margin. The reason is that the number of optimization parameters is immense, and it would be exceedingly difficult to search the hypothesis space in an efficient manner without utilizing machine learning methods. In addition, the transaction landscape is dynamic with respect to time; optimal strategies continue to change over periods of time, and an ideal optimization logic would satisfy this requirement. In addition, businesses also experience changes in their product line. The maintenance requirements for a diverse set of industries and product inventories is very large. These three factors, dynamic marketplaces, product changes, and maintenance, present a strong motivation to utilize artificial intelligence techniques rather than manual methods.

Reinforcement Learning

Imagine an autonomous agent which is presented with the task of traversing a complex maze repeatedly, seeking one of several exits. Furthermore, imagine that there are different starting points into which the agent is placed. The task of the agent becomes one of learning the maze, and of identifying the minimal distance path to an exit for a random starting location. The agent receives limited information from the environment, such as the shape of the current room, and also is given a restricted set of actions, such as turning left, or moving forwards and backwards.

The task of the autonomous agent falls into the realm of reinforcement learning. Since the agent is not previously presented with optimal solutions nor an evaluation of each action, the agent must repeatedly execute sequences of actions based on states that the agent has encountered. Furthermore, a reward is distributed at a chosen condition, for example, reaching an exit stage, or after a fixed number of actions have transpired.

Exploitation versus Exploration

The important notions of exploration and exploitation can be evidenced by the example of the k-armed bandit problem. An agent is placed in a room with a collection of k gambling machines, a fixed number of pulls, and no deposit required to play each machine. The learning task is to develop an optimal payoff strategy if each gambling machine has a different payoff distribution. Clearly, the agent can choose to pull only a single machine with an above average payoff distribution (reward), but this can still be suboptimal compared to the maximal payoff machine. The agent, therefore, must choose between expending the limited resource, a pull, against a machine with a known payoff (exploitation), or instead, to try to learn the payoff distribution of other machines (exploration).

The Jupiter Learning Approach

This section serves to present an overview of the methods and logic underlying the Jupiter system, and how Jupiter may be used with embodiments of the present invention.

In any economic exchange, such as a business transaction, there are several parties involved, often the producer or seller, and the consumer. In upsell transactions initiated by a third party, however, the third party itself is another party in the transaction. The fundamental abstract economic principle that guides transaction activity involves a cost-benefit analyses. Summarized, if the benefits of a transaction outweigh the costs, then the transaction is favorable. Furthermore, possible exchanges can be ranked according to this discriminative factor.

In the upsell transaction domain, therefore, there exist three parties, the customer, the host business, and the third party. Jupiter serves as an intelligent broker that seeks to generate upsell offers that are beneficial for all parties involved. Consider the consequences of violating this principle. Either the customer would never accept an upsell the host business would be threatened by “gaming”, or the third party would not receive an optimal profit.

Jupiter seeks to create a win-win-win situation for the three parties involved by employing learning technology on two levels. The first level is to determine the maximal utility action that can be performed with respect to the consumer. This is performed by utilizing data mining techniques and unsupervised learning algorithms. Once the possible actions with respect to the consumer have been generated, they are evaluated by a supervised neural network which considers the cost-benefit with respect to the third party and the host business.

The generation of upsell offers can be intrinsically tied in with the consumer needs. However, information should be propagated among any participating establishment, and that any retail sector or business practice is a potential deployment target.

When one asks what knowledge is of the highest utility to be shared in this sort of environment, the answer is the most robust, time-varying, abstract information. In order to achieve the more utility, therefore, knowledge should be represented in as an abstract form as possible. If coincidence dictates that very specific information can be shared, this is also acceptable, but should be considered a by-product of the true utility of the learning/brokering agent.

A sample of such information can be described by the English sentence:

“Offer a high customer benefit item, and also offer an item with high profit to a third party.”

One possible GP representation would be:

(SORT OfferRelevancy, SELECT Top, SORT Customer Benefit, SELECT Top)

The Unsupervised Step: Automatically Learning the Domain Using Probabilistic Modeling (Markov Model) and Bayesian Classification

Introduction

Imagine that one is placed in a completely foreign business environment, with the task of fulfilling the upsell generation requirement. An excellent strategy to pursue would be to first observe the transactions that are occurring, and to analyze what items (resources) are being sold together. This is because transactions are often initiated in order to satisfy a particular resource need for a customer. In the QSR industry, this may be a food need. In other industries, this may be needs such as children's back-to-school shopping, or a dining room furniture shopping instance. It would be exceedingly useful if there was a learning method which could:

Generalize over the items of a transaction

Produce an upsell tailored for that transaction

Dynamically and efficiently incorporate new transactions into its learned behavior

This is precisely what the unsupervised learning module of Jupiter seeks to do. The basic idea is that there is a lot of information to be gained from analyses of a particular transaction. This information is amplified through association with a previous memory of past orders over different customers and time frames.

The unsupervised components of Jupiter may utilize both a repository of historical data collected over the entire lifespan of the installation, and in addition, may maintain a “working memory” of the recent transactions that have transpired. This is to account for considerable deviations from the daily norm which are reflected by processes such as promotions, weather, holidays, and so forth. The weighting of the two distributions can be modified dynamically.

Markov Modeling

A Markov process attempts to describe data using a probabilistic model involving states and transitions. The idea is that transitions from one state to another are described probabilistically, based only on the previous state (the Markov principle). The probability of any arbitrary path through the space of states, therefore, can be assigned a probability based on the transition likelihoods.

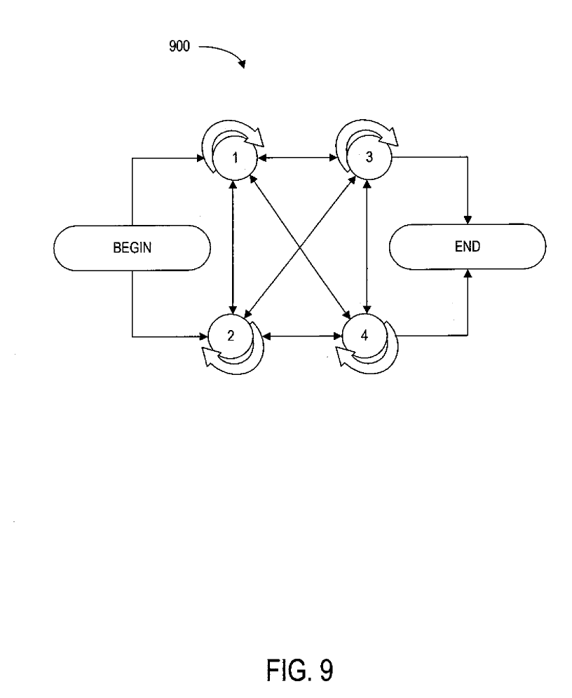

In order to account for the inhomogeneities introduced by the termini of sequences, BEGIN and END states are therefore introduced, as illustrated by the graph 900 in FIG. 9:

The Algorithm

A set of nodes, each corresponding to a menu item, are first constructed. The enumeration of the menu items permits the processing of an order as a series of states associated with transitions to states of increasingly greater inventory numeric tags. This therefore disqualifies half of the possible transitions allowed.

A transaction is first converted to a transition path, and the Markov model is modified using these observed values. The probabilities are then renormalized. At this point, the Markov model represents an accurate stochastic description of the transactions that it has observed, as described by the following equation:

$$P ( {s}_{b} , {s}_{0} ) P ( {s}_{k} , {s}_{e} ) {\prod }_{i = 0}^{k} P ( {s}_{i} , {s}_{i + 1} )$$

Offers are generated by calculating the probability of “inserting” an additional transition into the original transaction sequence. All menu items are then potentially assigned a relevancy based on this probability.

### EXAMPLE

A customer places the following transaction:

| Items | Jupiter Node Designation |
|---|---|
| Hamburger | 102 |
| Hamburger | 102 |
| French Fries | 225 |
| Small Coke | 332 |

The transition sequence is then:

(BEGIN, 102), (102, 102), (102, 225), (225, 332), (332, END)

To compute the estimated relevance of an offer, say Apple Pie (node 311), we insert that offer into the transition sequence:

(BEGIN, 102), (102, 102), (102, 225), (225, 311), (311, 332), (332, END)

By multiplying the transition probabilities, we arrive at the total path probability. This is likewise performed for all offers, and these values are then presented to the Jupiter Genetic Programming module along with the Bayes classification (see below).

Markov models are extremely applicable to situations where the state of a system is changing depending on the input (current state). However, they can also be utilized as measures of probability for particular sequences even when the data is derived from a stateless probabilistic process. For example, Markov modeling has successfully been applied to classify regions of genetic information based on the nucleotide sequence. Furthermore, the Markov technique can be used as a generative model of the data, in order to derive exemplary paths. The limitation of dependence on the previous state can be overcome by using higher-order or inhomogeneous Markov chains, but the computation becomes much more expensive, and Jupiter presently does not utilize these variants.

Bayesian Classification

The other form of unsupervised, or observation-based learning that Jupiter will employ is a Bayes classifier. The Bayes module will estimate the offer relevancy based on collected data of previous transactions given a set of attributes and values. The set of attributes and values in this case correspond to the internal menu item nodes, with the values being one or zero for inclusion or exclusion in the order.

The target classifications, corresponding to offers, are independent of the orders. This is achieved by only training the Bayes classifier with transactions in which an offer has been accepted. Furthermore, the distribution of the actual order with respect to the offer is irrelevant for training the classifier.

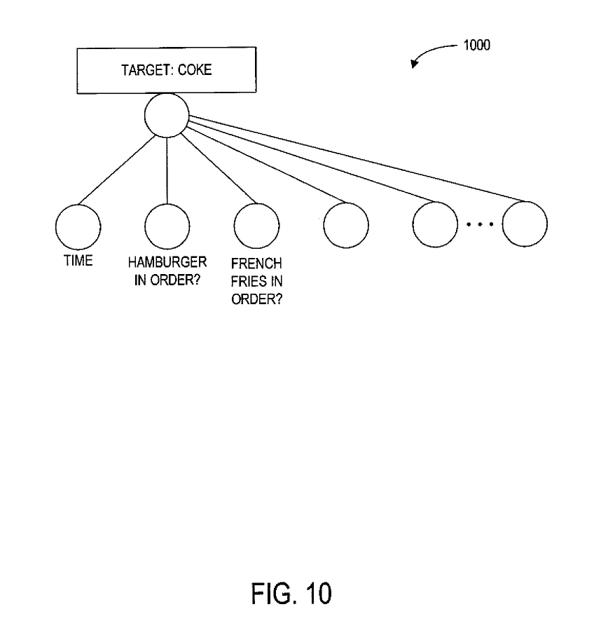

FIG. 10 illustrates in a graph 1000 an example of one menu item node, corresponding to a Coke, representing a target classification. Attributes such as time and general characteristics of the order are included for the classification. The weights extending from the target node correspond to conditional probabilities of the target given that particular attribute value.

By calculating the conditional probabilities over the set of attributes and values for each target classification (menu item), the potential offer relevancy (or likelihood of acceptance) can be calculated.

The Learning Algorithm

The Bayes classification module implemented in Jupiter is a variant of a Naïve Bayes Classifier (NBC). The NBC assumes that all attribute values are conditionally independent of each other; this assumption is almost certainly violated in the QSR domain. If the assumption were to hold, then it has been shown that no other learning mechanism using the same prior knowledge and hypothesis space can outperform the NBC. However, in many real-world cases, the independence principle does not hold, but the utility of the NBC is often comparable to the highest-performance algorithms examined.

The Jupiter NBC shall generate estimates for the offer relevancy based on conditional probability over a set of attributes including the time of day, and the inclusion of other menu items in the order. When generating estimates, an m-estimate method shall be utilized which will enable prior knowledge to be integrated into the NBC. The classifier will then modify the conditional probabilities based on each observed transaction. The task of evaluating a potential offer then becomes one of calculating the conditional probability of the target given the order parameters. In this way, a classification distinct from the Markov approach described earlier is also incorporated into the transaction parameters for evaluation by the genetic programming module (see below).

The Random Model

One of the most important questions one can ask regarding both unsupervised modules described previously and the reinforcement module is the performance versus a completely random approach. Only by comparison of the presently-described learning systems against the random model can an accurate estimation of the utility be derived. Furthermore, this baseline will allow intelligent modifications of the system to achieve better performance. For the prototype, toggles will be present that will allow switching particular modules on/off. For example, bypassing the offer relevancy modules will indicate the magnitude of contribution of the actual order relative to the accept status of the offer in regards to an individual's decision-making process. Factors such as discount percentage might influence the accept decision much more than any other parameters.

The Reinforcement Step: Optimizing the Transaction

Introduction

The reinforcement-learning module is responsible for dealing with the highest level of abstraction, and is entitled with the task of performing the cost-benefit analyses for a transaction. When we considering the notion of exchanging knowledge, this is the primary information that will be exchanged (though as described previously, if knowledge is to be exchanged within the same brand, a larger amount of information can be shared).

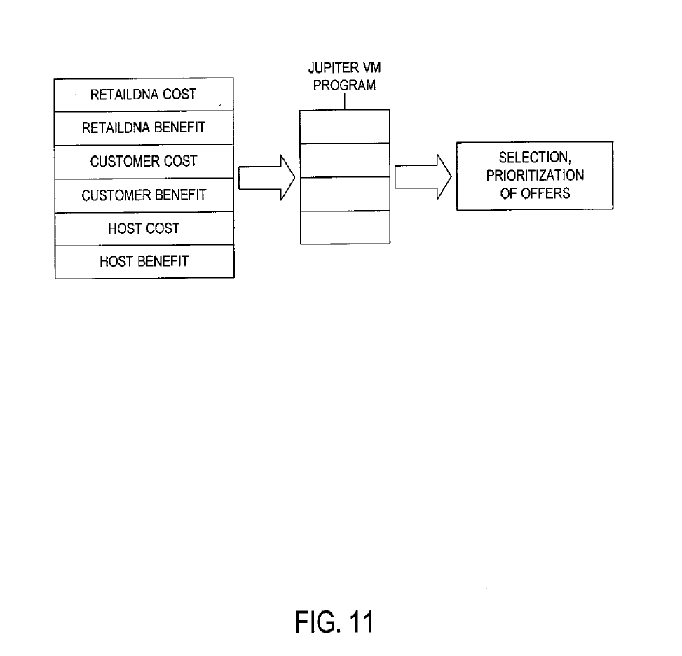

The design of the reinforcement learning system consists of evaluating the universal transaction parameters for each party, as illustrated by the diagram 1100 of FIG. 11

As is evident, this type of analyses can be most directly cast as regression analyses utilizing neural networks. In fact, a neural network module has been implemented to achieve this. However, there are several reasons why Genetic Programming (GP) will be utilized instead:
The evolutionary programming paradigm is more “naturally” amenable to reinforcement learning (e.g., an abstract measure of fitness vs. the error surface)
The situation may be quite dynamic with respect to time; this is further magnified by environments in which multiple Jupiter agents are competing (for example, multiple stores in a local region). This necessitates a learning technique which can react very efficiently to a varying business landscape
The evolutionary programming paradigm is in the spirit of embodiments of the present invention.
New terminals, representing additional considerations for the evaluation function for offer inclusion, can easily be inserted.
The programs can be interpreted and understood by humans more conveniently

There are also advantages to using a neural network representation of the upsell maximization function, but the genetic programming technique will be utilized in the prototype.

The Learning Algorithm

The basic idea behind genetic programming is to evolve both code and data as opposed to data alone. The objective is to create, mutate, mate, and manipulate programs represented as trees in order to search the space of possible solutions to a problem.

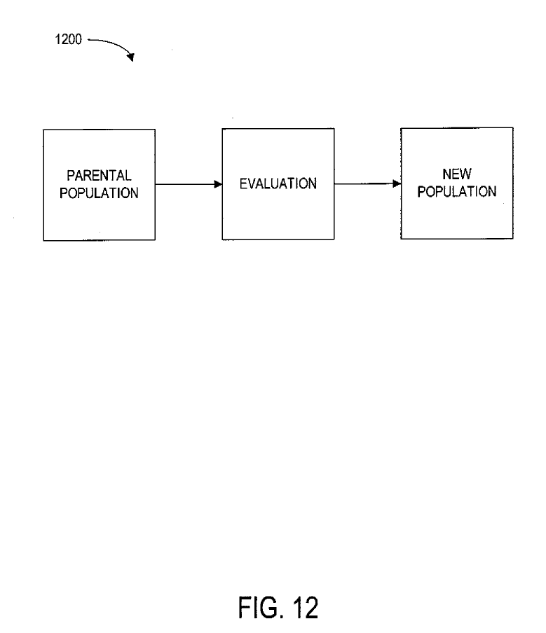

As illustrated by the diagram 1200 of FIG. 12, the algorithm consists of generating and maintaining a population of genetic programs represented by sequential programs operating in the Jupiter virtual machine. The programs are then evaluated and assigned a fitness. A new population is then created from the original parental population by selection based on fitness, mating, and mutation. In this manner, solutions to the desired function can be produced efficiently. A population size of 500 was chosen as a starting point for the prototype version based on the estimation that 1000 transactions will be processed per day. This allows every individual to have two opportunities to participate in evaluating an offer. The reason this is important is because since the fitness are distributed according to an absolute measure first (and then normalized), it is very possible for a “good” individual to have been assigned orders that generate a low maximum possible fitness if only one evaluation is performed. Of course, an even greater number of transactions could be processed before generating a new population, but this is a tradeoff between evolution and fitness approximation.

An intriguing possibility is to allow programs to modify themselves during evaluation. This potentially addresses the notion of the Baldwin effect and Lamarckian models of learning and evolution. In molecular biology, there is not necessarily a one to one correlation between the nucleotide sequence and the final protein product; a tremendous amount of regulation and modifications exist in the intermediate stages.

The Jupiter Virtual Machine

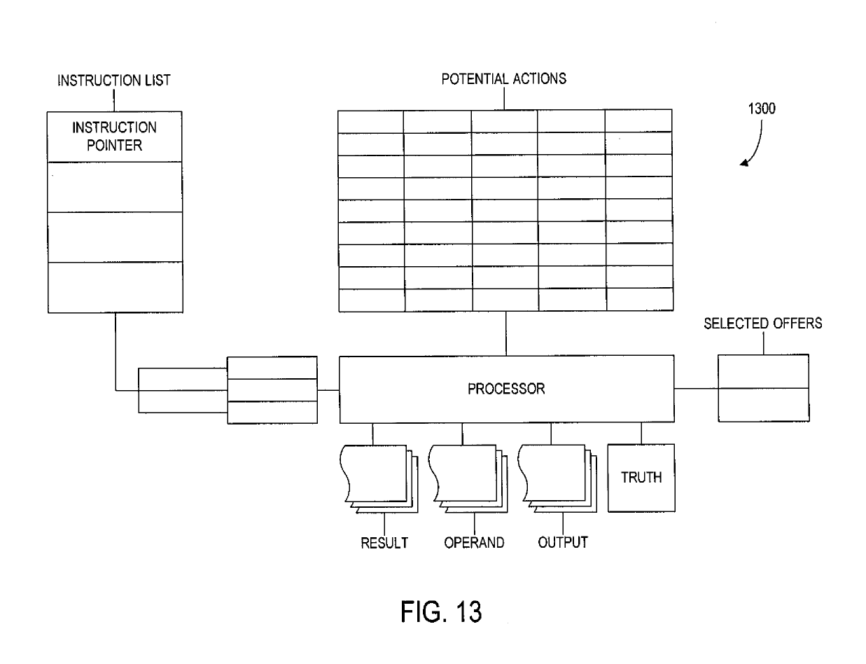

Referring to FIG. 13, an embodiment of the Jupiter Virtual Machine 1300 consists of three stacks, a truth bit, an instruction pointer, the instruction list (program), and the input data:

The instruction set for Jupiter Virtual Machine, depicted in TABLES 17 and 18, consists of instructions, which can compare instructions, and transfer or select particular actions.

TABLE 17

| INSTRUCTIONS | DESCRIPTION |
|---|---|
| PUSH | Transfer an action from one stack to another. |
| PUSHT | Transfer an action from one stack to another if the |
| | truth bit is on. |
| PUSHF | Transfer an action from one stack to another if the |
| | truth bit is off. |
| POP | Remove an action from a stack to another. |
| POPT | Remove an action from a stack to another if the truth |
| | bit is on |
| POPF | Remove an action from a stack to another if the truth |
| | bit is off. |
| > | Compare the top two actions in the operand stack |
| | specified by a parameter and set the truth bit if the |
| | first has a larger value. |
| < | Compare the top two actions in the operand stack |
| | specified by a parameter and set the truth bit if the |
| | first has a smaller value. |
| EQUALS | Compare the actions specified by two stacks and set |
| | the truth bit if they are identical. |
| SORT | Sort the input stack specified by a parameter into the |
| | result stack. |
| FINDMAX | Find the action with the maximum value for a |
| | specified parameter and place into the result stack. |

TABLE 18
Jupiter Action Parameters

| | | | |
|---|---|---|---|
| DISCOUNT | BAYES | MARKOV | PROFIT |
| PERCENTAGE | CLASSIFICATION | CLASSIFI- | TO THIRD |
| | | CATION | PARTY |
| PREPARATION | PROMOTION | INVENTORY | HOST |
| TIME | VALUE | | PROFIT |

The above constitute the core instructions utilized in the Jupiter genetic programming module. In addition, architecture-modifying instructions such as automatically defined functions and automatically defined loops allow the generation of more compact and powerful programs. Because each instruction is defined as an object, dynamic generation of new functions is easily accomplished.

The unsupervised modules generate a set of potential offers, each scored separately according to a customer benefit calculation based on the Bayes and Markov activation values. The task of the genetic programs then becomes one of mapping a set of inputs to a set of generated offers.

The separation of abstract pricing information with the semantics of an order constitutes the core of the Jupiter learning system. The system is able to automatically learn the nature of the inventory it is dealing with, but uses abstract pricing structure information to generate offers. Since the pricing structure information is universal, this knowledge can be shared across any business domain. The pricing structure of an item relates to its discount percentage, promotion value, profit margin, and so forth. This information can apply to any item in any industry. The values are normalized using statistical z-scores and relative magnitudes.

The power of evolutionary programming is realized in the potential space that can be searched. However, increasing the size of the space (by the addition of terminals that will not be utilized) can result in a higher amount of computation to achieve a desired level of performance. Therefore, the terminals that have been chosen in Jupiter constitute a basic set of operations rather than an elaborate and exhaustive array of functions.

In addition, if we can apriori predict what kind of functions the optimal function will most likely utilize, we can introduce these biases into the genetic programming system as predefined functions. For example, rather than explicitly learning to compute the third-party profit equation, this value is supplied as an input parameter.

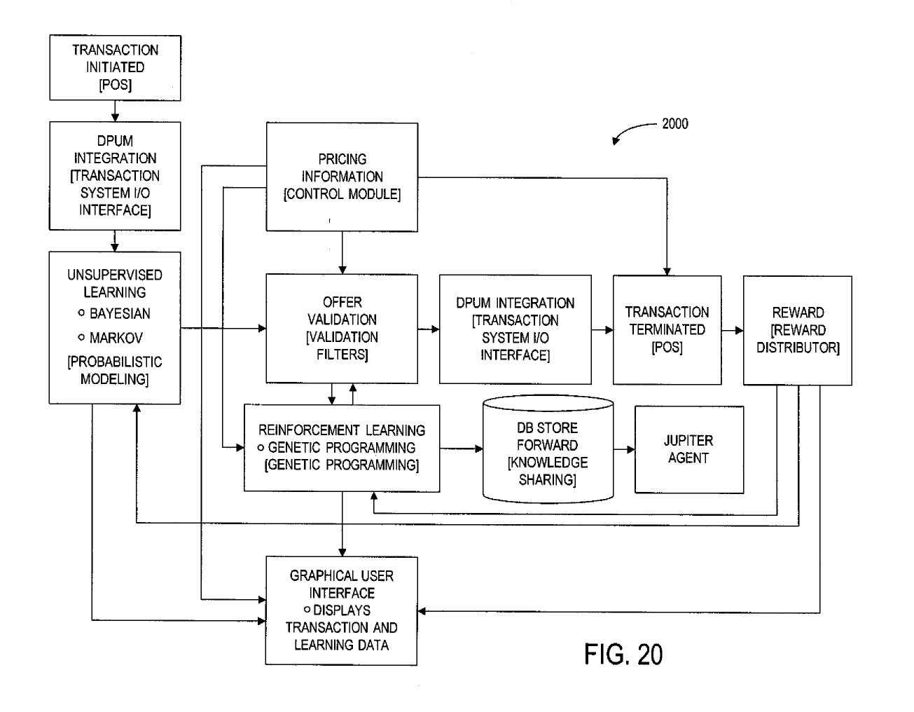

FIG. 20 depicts an overview 2000 of one embodiment of the Jupiter Architecture.

Graphical User Interface

The large number of parameters and options available in the Jupiter learning agent necessitates a GUI for monitoring the status of an agent. The GUI allows examination of the transactions that are pending offer generation, transactions that are pending offer acceptance, and transaction which are pending learning by the Jupiter agent. In addition, visual displays of the Markov model, Bayes classifier, and Genetic programs are accessible to facilitate performance monitoring. An important design issue that had to be considered, however, was the capability to modify the learning parameters. It is unrealistic that anyone outside of the third party (involved in the upsell) would need to do this, or would be sufficiently experienced to do so. Therefore, the ability to change the actual learning process has not been incorporated into the GUI, but can be done outside of the interface.

A description of the primary learning parameters is presented:
Jupiter Heartbeat
Unsupervised Module
   Memory Size
   m-estimate method
GP
   Population Size
   Relative weights for mutation, crossover, architecture-modifications, and Selection

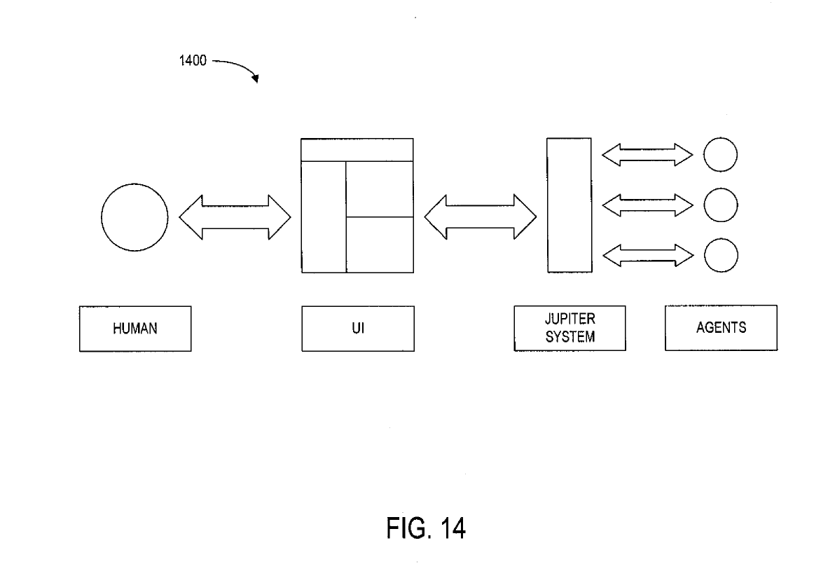

In addition, an evaluation window allows immediate classification by the agent. The GUI is a skeleton model for any Jupiter agent. All that is required is that the agent register with the UI to enable monitoring., using RMI technology. This is illustrated by the diagram 1400 in FIG. 14.

Jupiter Event Model and Control Module

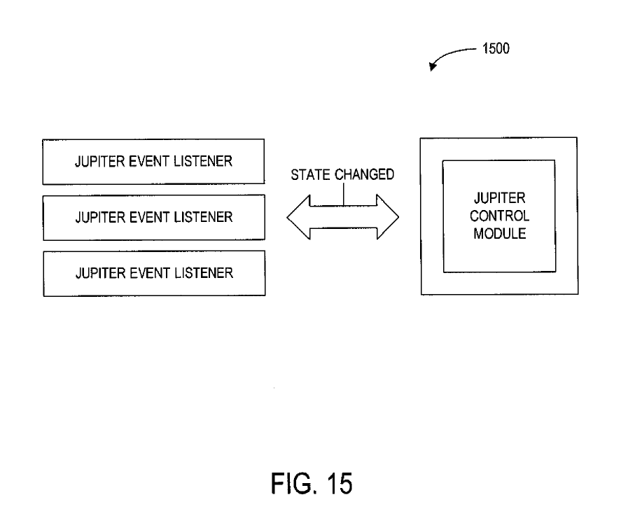

Referring to FIG. 15, the Jupiter agent is composed of a number of different modules, each linked to a state repository and a GUI. Therefore, the propagation of events becomes a crucial issue. This is further compounded by the multi-threaded nature of the Jupiter agent. Therefore, an event model has been developed and implemented that allows changes in component to be detected by other modules which have dependencies on that information. Furthermore, the distributed environment in which multiple Jupiter agents will coexist simultaneously necessitates a suitable event model 1500 to remotely gather state information pertaining to each agent.

The control module allows dynamic retrieval of the entire menu corresponding to a particular store. The constraints are independent of the industry, and can further be modified online using the GUI. For example, the design enables one to change the price of an item, and then store the modified constraint information back to the database. However, because interoperability issues with other residing systems, such as the POS and DPUM units, this feature has 1 not yet been. The purpose of the control module is to allow the cost-benefit analyses described previously to occur, independent of the particular store that the agent is in. By either swapping the agent or the control module, knowledge sharing can be implemented.

Validation Filter

The validation filter ensures that only those offers which increase revenue are generated. This is important because the learning methods have some degree of randomness. In addition, the validation filter also ensures that two offers are generated at every instance. In situations where the unsupervised learning may fail to identify two possibilities (with insufficient training), valid offers are created. In situations where the GP module fails to generate the correct number of offers, valid offers are also generated. However, there is no reward received for the action where an item generated by this filter is accepted. Valid offers are probabilistically generated according to pricing and past association. In the absence of a time period designation, and inventory description, these are the two most relevant attributes contributing to offer validity.

The validation filter is not the site at which randomization would be performed to eliminate third party/Customer/Cashier gaming. Rather, it is merely a module, which in at least one embodiment guarantees that the most minimal business requirements are met by guaranteeing offers that never result in a loss, and by guaranteeing that at least two will be presented.

Reward Distributor

The reward distributor is an important modules in the Jupiter system. Because the reinforcement learning is characterized by a mapping from a reward to a fitness, the nature of the reward function guides the evolution of the genetic programs. A GUI may allow the user to select among a number of possible reward functions, such as accept rates or sales revenue increase.

Transaction Database I/O Interface

The interface supports evaluation of transactions from historical data and from files. In this environment, the optimal performance of the Jupiter agent is defined by the DPUM logic. However, because of the reduced complexity of this environment, because all possible state-action pairs need not be considered, the historical data can serve a useful role as a simulation of an actual commercial environment.

DPUM Integration

The integration with the pre-existing POS/transaction-processing systems may be implemented by using a JNI bridge, or by establishing the Jupiter system as a server proper, and transacting with data over a network connection. The server approach is attractive because it allows the two outside interfaces of a Jupiter agent: with the rest of the Jupiter system, and with the POS array, to be implemented in one module. The JNI approach, on the other hand, is attractive because of the simplicity. In at least one embodiment, the JNI interface is utilized.

Persistent Storage

Persistent storage may be implemented by writing the state of the learning agents into the local database using a JDBC connection. Jupiter may maintain its own set of tables for this purpose. One table may hold the weights for the unsupervised neural network, and an additional table may hold the genetic program population.

Currently, a polling application may draw all the data from a particular store back to a central repository for analyses. This application may be used to also draw all the Jupiter tables back. After analyzing the performance of many stores, appropriate knowledge sharing can be performed.

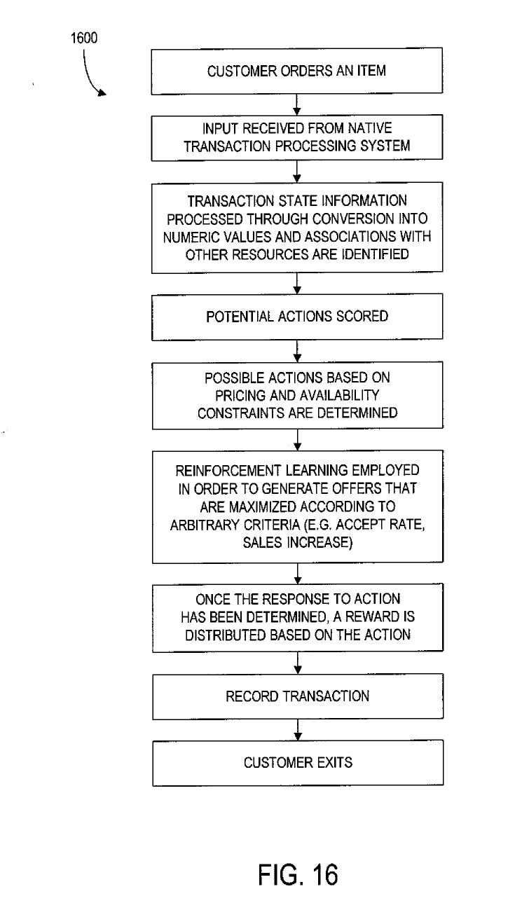

An exemplary data flow 1600 is illustrated in FIG. 16, which describes both transaction events an the Jupiter Module involved in the event.

Knowledge Sharing

One of the most important theoretical issues regarding capabilities of embodiments of the present invention is the notion of knowledge generalization. We wish to maximize the utility of the system on at least two levels:
First, the embodiments of the present invention may seek to optimize revenue generated at a particular store, both with respect to the host business, and for a provider of an embodiment of the present invention. It is therefore important to consider the notion of multi-agent transaction evaluation.
Second, embodiments of the present invention may seek to distribute knowledge that has been generate from each store, or types of industrial domain, across other business environments.

The knowledge that may be shared includes, for example, the evolved programs. These entities are universal because they operate only in the pricing domain. Each store can then represent a component in the ecosystem, and therefore, each population competes for a niche in the environment.

Knowledge sharing may entail the migration of selected individuals from one store into another.

Agent Architectures

There are several possibilities regarding the architecture of interconnected Jupiter agents.

The parallel architecture involves a powerful node processing all of the data and generating rewards. The fitness of a large population of genetic programs is evaluated in this manner, and high fitness individuals are then transferred to specific host businesses.

The distributed architecture involves a single Jupiter agent at each store, with its own population of evolving programs.

Hybrid architectures involve both a central learner (at a third party) in addition to local Jupiter agents. The central learner can generalize across larger regions and has access to a greater number of transactions, whereas the local population can generate programs which are specific to that environment.

Among these, the fully distributed version captures the full power of genetic programming because evolution can occur in parallel among a large number of individuals in different host environments. In the distributed architectures, each store environment can be thought of as a unique ecological niche, and the process of transferring individuals from one population to another can be regarded as a migration process.

Exemplary External Requirements

Processing Requirements

Jupiter may need to be moderately fast CPU at each installation. The actual learning algorithms and classification algorithms may be quite fast (100 ms for each transaction), but the procedure of building the unsupervised map may need to be performed over thousands of transactions. This is not required to be performed before each installation, but can be done instead online after the initial install. This is because of the guarantee not to generate inappropriate offers stipulated by the validation filters. Depending on the availability of a historical database, the choice between either online-only or previous batch learning can be made.

An “observation” mode may be employed for Jupiter (e.g., to introduce Jupiter into a completely novel business domain or brand, where the menu would be vastly different from other agents). In such an embodiment, for example, Jupiter may use only its validation filters for a period sufficient to build a representation of the underlying data. This would most likely involve less than a day of observation (depending on the transactional throughput of an installation). The advantages of this approach are:
Human training or interaction can be obviated
The learning system can go online within a relatively short period of time
This enables Jupiter/ embodiments of the invention to more closely resemble an “out-of the-box” solution

Jupiter will not need a central high performance computer. The distributed nature of the system allows the harnessing of hundreds or thousands of CPUs to evolve the population in a distributed fashion. However, the incorporation of Data Warehouse information will not degrade performance, and will permit the generation of more generalized individuals which will augment the locally evolved populations at each installation.

Exemplary Data Requirements

Each Jupiter agent will be instantiated upon startup by the DPUM system. Once the Jupiter agent has been created, flow of information between DPUM and Jupiter may occur via the JNI bridge.

Jupiter may maintain the following persistent storage, as described previously:
A SQL table corresponding to the weights of the unsupervised network. A rough estimate is that approximately 1-5 M of storage may be required for the network.
A SQL table corresponding to the individuals in the reinforcement learner population. This is of very variable size, but the estimate is about 500K-1M of storage for the entire population (500 individuals, 1K for each individual)

In addition, Jupiter may also require 2 additional tables for knowledge sharing. One will be utilized by the DPUM polling application in order to store and forward individuals. The other will be a repository for organisms that have migrated into the store.
A store-and-forward SQL table which contains the individuals that are migrating from one store into another. The maximum size of this table is of course, the maximum size of the population in the store (1M).
A repository SQL table which contains individuals which have migrated into the target store.
   Exemplary Communications Requirements

In the absence of high-speed/continuous links between stores, communication between Jupiter agents may necessitate a central “dispatcher” at a third party which shares agent information. The polling application that draws data from each store can be utilized to achieve this.

The possible of a fast/continuous connection among stores permits the circumvention of this step, and Jupiter agents will be able to directly share information with other, and remote offer generation will be possible.

Exemplary Requirements

Within Store (fast, continuous)
Access to local store's database for storing/retrieving transactions
Access to local store's database for storing/retrieving state information
   Between Store and third party (slow, intermittent)
Access to Data Warehouse for forwarding state information (knowledge sharing)
   Optional

Between Stores (slow, intermittent)
Access to other stores' databases for storing/retrieving state information

Between Stores (fast, continuous)
Remote offer generation
Access to other stores' databases for storing/retrieving state information

Between Store and third party (fast, intermittent) or (slow, continuous)
Remote configuration

Between Store and third party (fast, continuous)
Centralized learning version
Real-time remote monitoring of Jupiter activity
Remote configuration

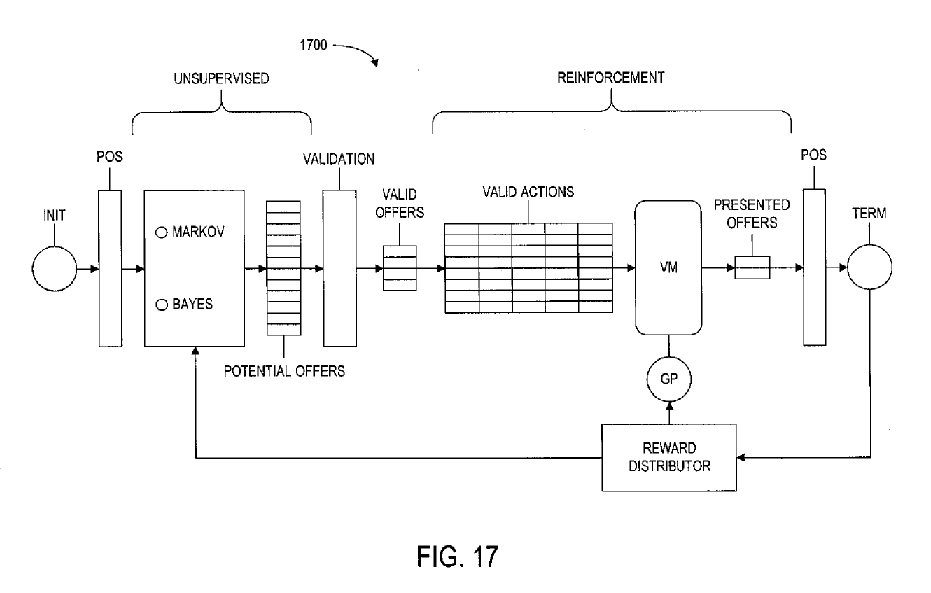

A diagram 1700 of the Jupiter system is illustrated in FIG. 17.

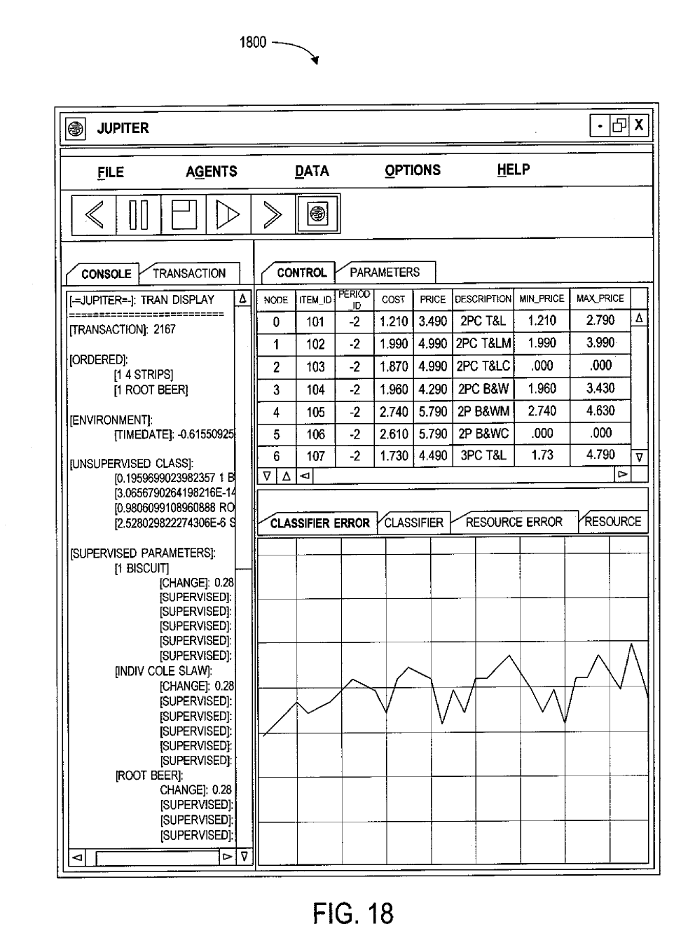

FIG. 18 depicts a window 1800 which describes the Jupiter control module (pricing/inventory information), the unsupervised learner (Resource), and the console for a single-step through a historical transaction. The order is displayed, along with the environment variables, and the classification (after filtering) of the unsupervised learner. The supervised parameters are then evaluated for each unsupervised classification. These will be the parameters that the reinforcement learner will have access to. Not shown in FIG. 18 is the transaction queues, which reveal the transactions waiting for offers to be generated, those that are waiting to be rewarded, and those that are waiting to be learned.

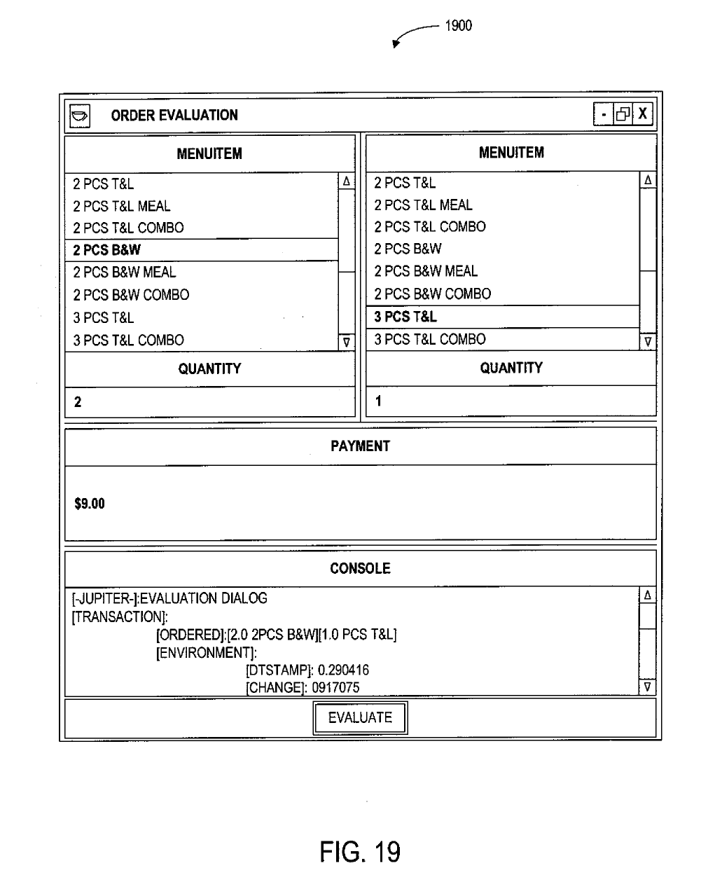

FIG. 19 depicts an evaluation dialog 1900 whereby the user can manually place an order to analyze the system. Menu items can be selected, the quantity specified, and a payment made. After evaluation, a full trace of the transactional through each of the modules is reported, along with the final offers.

Additional Features:

Learning of retail resource associations through unsupervised observation

A crucial feature of Jupiter is its ability to automatically learn the resource distributions and resource associations through observation using unsupervised learning methods. This enables the upsell optimization system to participate in an industrial domain, brand, or store without prior knowledge representation. As transactions are observed, the performance increases correspondingly.
Genetic programming to enhance upsell performance

The use of genetic programming to automatically create upsell optimization strategies evaluated by business attributes such as profitably and accept rate. Because this is independent of the particular retail sector, this knowledge can be shared universally with other Jupiter agents in other domains.
Use of a multi-component unsupervised-reinforcement learning system to optimize upsell offers.

Combining unsupervised and reinforcement learning techniques to automatically learn associations between resources, and to automatically generate optimized strategies. This is another key feature of the Jupiter system. By disentangling the resource learning module from the upsell maximizing module, we are able to share the relevant, universal information across any retail outlet. The final feature related to this design is that the reward can be specified dynamically with respect to time, and independently of a domain.

As will be apparent to those of ordinary skill in the art, various embodiments of the present invention can employ many different philosophical and mathematical principals and techniques, such as simple statistical systems and genetic algorithms. Described below are several known methods that could be used to implement embodiments of the present invention.

### Data Mining

Data mining is the search for valuable information in a dataset. Data mining problems fall into the two main categories: classification and estimation. Classification is the process of associating a data example with a class. These classes may be predefined or discovered during the classification process. Estimation is the generation of a numerical value based on a data example. An example is estimating a person's age based on his physical characteristics. Estimation problems can be thought of as classification problems where there are an infinite number of classes.

Predictive data mining is a search for valuable information in a dataset that can be generalized in such a way to be used to classify or estimate future examples.

The common data mining techniques are clustering, classification rules, decision trees, association rules, regression, neural networks and statistical modeling.

### Decision Trees

Decision trees are a classification technique where nodes in the tree test certain attributes of the data example and the leaves represent the classes. Future data examples can be classified be applying them to the tree.

### Classification Rules

Classification rules are an alternative to decision trees. The condition of the rule is similar to the nodes of the tree and represents the attribute tests and the conclusion of the rule represents the class. Both classification rules and decision trees are popular because the models that they produce are easy to understand and implement.

### Association Rules

Association Rules are similar to classification rules except that they can be used to predict any attribute not just the class.

### Statistical Modeling

A common statistical modeling technique is based on Baye's rule to return the likelihood that an example belongs to a class. Another statistical modeling approach is Bayesian networks. Bayesian networks are graphical representations of complex probability distributions. The nodes in the graph represent random variables, and edges between the nodes represent logical dependencies. In one embodiment, Baye's Rule may be used to determine that an offer will be accepted given an offer price and the items in the order.

### Regression

Regression algorithms are used when the data to be modeled takes on a structure that can be described by a known mathematical expression. Typical regression algorithms are linear and logistic.

### Cluster Analysis

The aim of cluster analysis is to partition a given set of data into subsets or clusters such that the data within each cluster is as similar as possible. A common clustering algorithm is K Means Clustering. This is used to extract a given number, K, of partitions from the data.

### Fuzzy Cluster Analysis

Like cluster analysis, fuzzy cluster analysis is the search for regular patterns in a dataset. While cluster analysis searches for an unambiguous mapping of data to clusters, fuzzy cluster analysis returns the degrees of membership that specify to what extent the data belongs to the clusters. Common approaches to fuzzy clustering involve the optimization of an objective function. An objective function assigns an error to each possible cluster arrangement based on the distance between the data and the clusters. Other approaches to fuzzy clustering ignore the objective function in favor of a more general approach called Alternating Cluster Estimation. A nice feature of fuzzy cluster analysis is that the computed clusters can be interpreted as human readable if-then rules.

### Neural Networks (“Neural Nets”)

Neural nets attempt to mimic and exploit the parallel processing capability of the human brain in order to deal with precisely the kinds of problems that the human brain itself is well adapted for. Neural networks algorithms fall into two categories: supervised and unsupervised.

The supervised methods are known as Bi-directional Associative Memory (BAM), ADALINE and Backward propagation. These approaches all begin by training the networks with input examples and their desired outputs. Learning occurs by minimizing the errors encountered when sorting the inputs into the desired outputs. After the network has been trained, the network can be used to categorize any new input.

The Kohonen self-organizing neural network (SON) is a method for organizing data into clusters according to the data's inherent relationships. This method is appealing because the underlying clusters do not have to be specified beforehand but are learned via the unsupervised nature of this algorithm.

Exemplary applications to the present invention include, but are not limited to, the following:
To predict which items are likely to be accepted for a given order.
To predict the likelihood that a given item will be accepted for a given order.
To cluster similar orders together
To classify order items into categories
To understand how changes in one variable of the data affects another. More specifically, to determine if something like the day of the week or the offer price affects the rate of acceptance. This is called a Sensitivity Analysis.
Can be used in concert with some of the evolutionary techniques discussed below. For example, the outputted classes or estimations can be used as variables in an evolutionary algorithm.
The output of many of the algorithms can be translated to human readable rules.

One of ordinary skill in the art may refer to the following references which describe Data Mining:
Fuzzy Cluster Analysis, Methods for Classification, Data Analysis and Image Recognition, Frank Hoppner, Frank Klawonn, Rudolf Kruse, Thomas Runkler, 1999, John Wiley & Sons Ltd
Machine Learning and Data Mining Methods and Applications, Ryszard S. Michalski, Ivan Bratko, Miroslav Kubat, 1998, John Wiley & Sons Ltd
Solving Data Mining Problems Through Pattern Recognition, Ruby L. Kennedy, Yuchun Lee, Benjamin Van Roy, Christopher D. Reed, Richard P. Lippman, 1995-1997, Prentice-Hall, Inc.
Data Mining, Ian H. Witten, Eibe Frank, 2000, Academic Press
Object-Oriented Neural Networks in C++, Joey Rogers, 1997, Academic Press

### Evolutionary Algorithms

Evolutionary Algorithms are generally considered search and optimization methods that include evolution strategies, genetic algorithms, ant algorithms and genetic programming. While data mining is reasoning based on observed cases, evolutionary algorithms use reinforcement learning. Reinforcement learning is an unsupervised learning method that produces candidate solutions via evolution. A good solution receives positive reinforcement and a bad solution receives negative reinforcement. Offers that are accepted by the customer are given positive reinforcement and will be allowed to live. Offers that are not accepted by the customer will not be allowed to live. Over time, the system will evolve a set of offers that are the most likely to be accepted by the customer given a set of circumstances.

### Genetic Algorithms

Genetic Algorithms (GAs) are search algorithms based on the concept of natural selection. The basic idea is to evolve a population of candidate solutions to a given problem by operations that mimic natural selection. Genetic algorithms start with a random population of solutions. Each solution is evaluated and the best or fittest solutions are selected from the population. The selected solutions undergo the operations of crossover and mutation to create new solutions. These new offspring solutions are inserted into the population for evaluation. It is important to note that GAs do not try all possible solutions to a problem but rather use a directed search to examine a small fraction of the search space.

### Classifier Systems

One example of a genetic algorithm is a classifier system. A classifier system is a machine learning system that uses “if-then” rules, called classifiers, to react to and learn about its environment. A classifier system has three parts: the performance system, the learning system and the rule discovery system. The performance system is responsible for reacting to the environment. When an input is received from the environment, the performance system searches the population of classifiers for a classifier whose “if” matches the input. When a match is found, the “then” of the matching classifier is returned to the environment. The environment performs the action indicated by the “then” and returns a scalar reward to the classifier system. One should note that the performance system is not adaptive; it just reacts to the environment. It is the job of the learning system to use the reward to reevaluate the usefulness of the matching classifier. Each classifier is assigned a strength that is a measure of how useful the classifier has been in the past. The system learns by modifying the measure of strength for each of its classifiers. When the environment sends a positive reward then the strength of the matching classifier is increased and vice versa. This measure of strength is used for two purposes: when the system is presented with an input that matches more than one classifier in the population, the action of the classifier with the highest strength will be selected. The system has “learned” which classifiers are better. The other use of strength is employed by the classifier system's third part, the rule discovery system. If the system does not try new actions on a regular basis then it will stagnate. The rule discovery system uses a simple genetic algorithm with the strength of the classifiers as the fitness function to select two classifiers to crossover and mutate to create two new and, hopefully, better classifiers. Classifiers with a higher strength have a higher probability of being selected for reproduction.

XCS is a kind of classifier system. There are two major differences between XCS and traditional classifier systems:

As mentioned above, each classifier has a strength parameter that measures how useful the classifier has been in the past. In traditional classifier systems, this strength parameter is commonly referred to as the predicted payoff and is the reward that the classifier expects to receive if its action is executed. The predicted payoff is used to select classifiers to return actions to the environment and also to select classifiers for reproduction.

In XCS, the predicted payoff is also used to select classifiers for returning actions but it is not used to select classifiers for reproduction. To select classifiers for reproduction and for deletion, XCS uses a fitness measure that is based on the accuracy of the classifier's predictions. The advantage to this scheme is that since classifiers can exist in different environmental niches that have different payoff levels and if we just use predicted payoff to select classifiers for reproduction then our population will be dominated by classifiers from the niche with the highest payoff giving an inaccurate mapping of the solution space.

The other difference is that traditional classifier systems run the genetic algorithm on the entire population while XCS uses a niche genetic algorithm. During the course of the XCS algorithm, subsets of classifiers are created. All classifiers in the subsets have conditions that match a given input. The genetic algorithm is run on these smaller subsets. In addition, the classifiers that are selected for mutation are mutated in such a way so that after mutation the condition still matches the input.

Shifting Balance Genetic Algorithm (SBGA)

The SBGA is a module, which can be plugged into a GA, intended to enhance a GA's ability to adapt to a changing environment. A solution that can thrive in a dynamic environment is advantageous.

Cellular Genetic Algorithm (CGA)

The CGA is another attempt at finding an optimal solution in a dynamic environment. A concern of genetic algorithms is that they will find a good solution to a static instance of the problem but will not quickly adapt to a fluctuating environment.

### Genetic Programming

Genetic programming (GP) is an extension of genetic algorithms. It is a technique for automatically creating computer programs to solve problems. While GAs search a solution space, GPs search the space of computer programs. New programs can be tested for fitness to achieve a stated objective.

### “Ant” Algorithms

An ant algorithm uses a colony of artificial ants, or cooperative agents, designed to solve a particular problem. The ants are contained in a mathematical space where they are allowed to explore, find, and reinforce pathways (solutions) in order to find the optimal ones. Unlike the real-life case, these pathways might contain very complex information. When each ant completes a tour, the pheromones along the ant's path are reinforced according to the fitness (or “goodness”) of the solution the ant found. Meanwhile, pheromones are constantly evaporating, so old, stale, poor information leaves the system. The pheromones are a form of collective memory that allows new ants to find good solutions very quickly; when the problem changes, the ants can rapidly adapt to the new problem. The ant algorithm also has the desirable property of being flexible and adaptive to changes in the system. In particular, once learning has occurred on a given problem, ants discover any modifications in the system and find the new optimal solution extremely quickly without needing to start the computations from scratch.

Possible applications to embodiments of the present invention are:
Search the space of all possible offers to find the offers that are most likely to be accepted
Search the space of all possible offers to find the most profitable offers that are likely to be accepted
Evolutionary algorithms can be used together with data mining solutions. For example, a data mining solution could return a score representing the likelihood that an offer will be accepted. Each offer item could have many scores based on different parts of the order. An evolutionary algorithm could be used to devise a strategy for selecting an item based on the collection of scores.

The genetic algorithm XCS and a statistical modeling technique may be combined to score all the offers. An evolutionary strategy known as Explore/Exploit may be used to select offers from the offer pool. Reinforcement learning may be used to improve the system.

The score of an offer should reflect the likelihood that an offer will be accepted given a particular order and may also include the relative value of an offer to an owner. Scores may also include information about how well an offer adheres to other business drivers or metrics such as profitability, gross margin, inventory availability, speed of service, fitness to current marketing campaigns, etc.

For example, in addition to those listed above, an order consists of many parts: the cashier, the register, the destination, the items ordered, the offer price, the time of day, the weather outside, etc. The BioNet divides the pieces of the order into a discrete part and a continuous part. Each part is scored independently and then the scores are combined to reach a final “composite” score for each item.

The discrete part of the order consists of the parts of the order that are disparate attributes: e.g., the cashier, the day of the week, the month, the time of day, the register and the destination. The XCS algorithm is used on the discrete part to arrive at a score.

The continuous part of the order consists of those parts that are not discrete attributes: the ordered items and the offer price. Conditional probabilities are used to score the continuous attributes. Another way to look at the two pieces is as a Variable part and an Invariable part. The variable part consists of the parts of the order that are likely to change from order to order, the items ordered and the offer price, while the invariable part consists of the stuff which is likely to be common among many orders, the cashier, register, etc.

### XCS

In order to apply the XCS algorithm, the order is first translated to a bit string of 1's and 0's. Only the so-called discrete parts of the order are translated. The ordered items and offer price are ignored. The population of classifiers is searched for all classifiers that match the order. The action of the classifier represents an offer item. By randomly creating any missing classifiers, the XCS algorithm guarantees that there exists at least one classifier for each possible offer item. The predicted payoffs of the classifiers are averaged to compute a score for each offer item. This score is combined with the score computed by the conditional probabilities to arrive at a final score for each offer item.

### Conditional Probabilities

Naïve Bayes may be used to calculate the conditional probability of an item being accepted given some ordered items and an offer price. Each ordered item and the offer price are treated as independent and equally important pieces of information. The conditional probabilities are calculated using Baye's Rule. Baye's Rule computes the posterior probability of a hypothesis H being true given evidence E:
Baye's Rule: P(H|E)=(P(E|H)P(H))/P(E)

In our case, the hypothesis is “Item X will be Accepted” and the evidence is the ordered items and the offer price. P(H) is called the “prior probability” or the probability of the Hypothesis in the absence of any evidence.

Since independence was assumed, the probabilities can be multiplied so the actual calculation is as follows:
[Product of for all items in the order[P(item|Offer Accepted)]*P(Offer Accepted)*P(Offer Price|Offer Accepted)]/P(Evidence)

Note that P(Evidence) may be ignored since it disappears as it is normalized.

The probabilities P(E|H) and P(H) are calculated from observed frequencies of occurrences. One facet different from classic data mining problems is that the environment is in a constant state of flux. The parameters that influence the acceptance or decline of an offer may vary from day to day or from month to month. To account for this, in various embodiments of the present invention, the system constantly adapt itself. Instead of using observed frequencies from the beginning of time, the only the most recent transactions are used.

Since the probabilities are multiplied, any P(E|H) or P(H) that is 0 will veto all the other probabilities. In the case of 0 probabilities, the Laplace estimator technique of adding 1 to the numerator and denominator is used.

Once all the offers have been scored, an Explore/Exploit scheme is used to select offers from the offer pool. To select the first item, the system randomly chooses with no bias either Explore or Exploit. If Explore is chosen then caution is thrown to the wind, the scores are ignored and an item is randomly selected from the offer pool. If Exploit is chosen then the item with the best score is selected. So, we use Explore to explore the space of all possible offers and we use Exploit to exploit the knowledge that we have gained. To select the second item, the system again randomly chooses between Explore and Exploit. By employing both Explore and Exploit, the system achieves a nice balance between acquiring knowledge and using knowledge. As a side effect, the Explore strategy also thwarts customer gaming. By periodically throwing in random offers, it is hard to anticipate the system. The problem with exploring is that very bad offers like offering a soda to an order containing a soda can still be presented. To reduce the likelihood but not eliminate the known bad offers, two kinds of Explore, “Completely Random” and “Somewhat Random”, are used. Completely Random is as discussed already. Somewhat Random selects an item with an “OK” score.

The system learns by receiving reinforcement from the environment. After an offer is presented, an outcome of either accept, cancel or decline is returned to the system. Both XCS and the observed frequencies of acceptance are updated based on the outcome.

### Evolutionary Algorithms References

One of ordinary skill in the art may refer to the following references which describe Evolutionary Algorithms:
Genetic Algorithms, David E. Goldberg 1989 Addison-Wesley
An Introduction to Genetic Algorithms, Melanie Mitchell, 1999, MIT Press
Probabilistic Reasoning in Intelligent Systems, Judea Pearl, 1988, Morgan Kaufmann Publishers, Inc.
An Algorithmic Description of XCS, Martin Butz, Stewart Wilson, IlliGAL Report No. 2000017, April 2000.
Enhancing the GA's Ability to Cope with Dynamic Environments, Mark Wineberg, Franz Oppacher, Proceedings of the Genetic and Evolutionary Computation Conference, July 2000.
An Empirical Investigation of Optimisation in Dynamic Environments Using the Cellular Genetic Algorithm, Michael Kirley, David G. Green, Proceedings of the Genetic and Evolutionary Computation Conference, July 2000.
Genetic Programming (Complex Adaptive Systems), John Koza, 1992, MIT Press
   Statistical or Traditional Self-improving Method

Standard statistical modeling methods can be used to achieve similar results of GA or other algorithms.

### Profit Engine Calculations

In order to maximize the return on Digital Deal offers, a method could be implemented to make the most profitable offers to the customer with the highest probability of acceptance. One way to accomplish this would be to add a new offer property: Popularity. If we weight the popularity of an offer high and the profitability high, we maximize the return.

Testing has shown that the likelihood of an item being accepted is influenced greatly by the cost of the order. In order to calculate the popularity of an offer item we regard the offer item with respect to the cost of the entire order and the previous acceptance rate of that item. Note: This approach will be extended to handle the issue of popularity based on other factors such as the total discount or value proposition.

Calculating the Popularity:

In order to calculate the popularity we define a function that returns the popularity of a given menu item based on the order total. The popularity is the predicted likelihood of acceptance at a given order total.

The popularity function is a least squares curve fit to the historical acceptance rates of an item. A second degree polynomial is being used for the curve fit. The popularity function is defined as follows:

Popularity=a xˆ2+b x+c

Where

X=Order total

A, B, C=popularity coefficients

Determining the data set to use for the curve fit is done as follows. The range of offers are divided up into increments (e.g. 50¢). All of the offers within a given range are averaged and the average take rate per increment is set. A curve is fit through the average take rate samples and the coefficients for the above function are calculated. These coefficients are stored in the database for each menu item.

A program may be run at a predetermined time (e.g. End of Day) to calculate the Popularity coefficients for each menu item. The user will need to set the order total increment and the minimum number of points per increment. This will allow for tuning of the system.

### Handling Limitations

In order to allow for increments that don't have sufficient data the following technique will be used. If an increment range (e.g. 0¢-25¢) has less than the minimum number of points it is merged with the next increment. This continues until the minimum number of points are found in an increment. If there is insufficient data to fit a curve (3 valid intervals) then a linear function (2 valid intervals) or a constant (1 or less intervals) will be used.

### Verification of a Valid Curve Fit

Each curve can be checked to see if there is a valid trend (meets a given threshold for standard deviation). If the curve fit is determined to be invalid then the average take rate for all offers of this item will be used as the popularity function.

### Putting it all Together

The goal of implementing the popularity attribute per offer is to score the offers according to the predicted probability of acceptance. The scoring engine will provide a method for weighting the popularity of an item in relation to the other score parameters. So, in order to maximize the most profitable offers and those most likely to be accepted you would weight the popularity and the profitability higher than any other score parameters.

### REFERENCES

One of ordinary skill in the art may refer to the following references for a description of learning systems.
[1]. MITCHELL T M. MACHINE LEARNING. 1997. MCGRAW-HILL: BOSTON
[2]. KAELBLING L P, LITTMANN M L, MOORE A W. 1996. REINFORCEMENT LEARNING: A SURVEY. J. ARTIFICIAL INTELLIGENCE RESEARCH 4: 237-285
[3]. CRITES R H, AND BARTO A G. IMPROVING ELEVATOR PERFORMANCE USING REINFORCEMENT LEARNING. ADVANCES IN NEURAL INFORMATION PROCESSING SYSTEMS 8. MIT: CAMBRIDGE.
[4]. KAELBLING L P. ASSOCIATIVE REINFORCEMENT LEARNING: A GENERATE AND TEST ALGORITHM. KLUWER: BOSTON.
[5]. ANDERSON C W. APPROXIMATING A POLICY CAN BE EASIER THAN APPROXIMATING A VALUE FUNCTION. 2000. COLORADO STATE UNIVERSITY TECHNICAL REPORT: CS-00-01
[6]. KAELBLING L P. ASSOCIATIVE REINFORCEMENT LEARNING: FUNCTIONS IN k-DNF. KLUWER: BOSTON.
[7]. OPITZ D, MACLIN R. 1999. POPULAR ENSEMBLE METHODS: AN EMPIRICAL STUDY. J ARTIFICAL INTELLIGENCE RESEARCH. 11: 169-198.
[8]. OPITZ D, SHAVLIK J W. 1997. CONNECTIONIST THEORY REFINEMENT: GENETICALLY SEARCHING THE SPACE OF NETWORK TOPOLOGIES. J ARTIFICIAL INTELLIGENCE RESEARCH 6: 177-209.
[9]. KACHIGAN S K. 1991. MULTIVARIATE STATISTICAL ANALYSIS. RADIUS PRESS: NEW YORK.
[10]. KOZA J. GENETIC PROGRAMMING III.
[11]. Gerhart J C, Kirschner M W. 1997. Cells, Embros and Evolution. Blackwell Sciences.

1. A method comprising:
receiving order information based on an order of a customer; and
determining an offer for the customer based on:
the order information and
at least one of
a genetic program and
a genetic algorithm.

2-8. (canceled)
